(19) United States
(12) Patent Application Publication
(10) Pub. No.: US 2024/0048398 A1
(43) Pub. Date: Feb. 8, 2024

(54) METHOD AND APPARATUS FOR CHARGING MANAGEMENT

(71) Applicant: Telefonaktiebolaget LM Ericsson (publ), Stockholm (SE)

(72) Inventors: Yingjiao HE, Shanghai (CN); Zhansheng WEI, Shanghai (CN); Yong YANG, Kållered (SE); Erik WIKSTRÖM, Göteborg (SE); Jinyin ZHU, Shanghai (CN); Min ZHU, Shanghai (CN)

(21) Appl. No.: 18/264,547

(22) PCT Filed: Feb. 9, 2022
(86) PCT No.: PCT/CN2022/075688

§ 371 Date: Aug. 7, 2023

(30) Foreign Application Priority Data
Feb. 10, 2021 (WO) PCT/CN2021/076462

(51) Int. Cl. H04L 12/14

(52) U.S. Cl. CPC H04L 12/1407

(57) ABSTRACT

Embodiments of the present disclosure provide method and apparatus for charging management. A method performed by a first user plane function includes determining a charging action for a first session. The method further includes sending information regarding the charging action for the first session to a second user plane function.

### TECHNICAL FIELD

The non-limiting and exemplary embodiments of the present disclosure generally relate to the technical field of communications, and specifically to methods and apparatuses for charging management.

### BACKGROUND

This section introduces aspects that may facilitate a better understanding of the disclosure. Accordingly, the statements of this section are to be read in this light and are not to be understood as admissions about what is in the prior art or what is not in the prior art.

An architecture of control and user plane separation (CUPS) of various network devices such as SGW (serving gateway), PGW (packet data network (PDN) gateway (GW)) and TDF (traffic detection function), etc. has been introduced in a communication network. For example, 3rd Generation Partnership Project (3GPP) TS 23.214 V16.2.0 and TS 29.244 V16.6.0, the disclosures of which are incorporated by reference herein in their entirety, have defined various interfaces between the control plane nodes (or functions) and the user plane nodes (or functions). As described in 3GPP TS 23.214 V16.2.0, an Sxb interface is defined between a PGW control plane (PGW-C) and a PGW user plane (PGW-U), an Sxa interface is defined between a SGW control plane (SGW-C) and a SGW user plane (SGW-U), and an Sxc interface is defined between a TDF control plane (TDF-C) and a TDF user plane (TDF-U). As described in 3GPP TS 29.244 V16.6.0, an N4 interface is defined between a Session Management Function (SMF) and User Plane Function (UPF). Moreover, 3GPP TS 23.214 V16.2.0 and TS 29.244 V16.6.0 have defined various packet forwarding control protocol (PFCP) node related procedures and PFCP session related procedures between the control plane nodes (or functions) and the user plane nodes (or functions).

3GPP TS 23.502 V16.7.1, the disclosure of which is incorporated by reference herein in their entirety, has described SMF Pause of Charging procedure. As described in clause 4.4.4 of 3GPP TS 23.502 V16.7.1, the SMF Pause of Charging procedure aims for the SMF charging and usage monitoring data to more accurately reflect the downlink traffic actually sent to the AN (access network). The following are example triggers for the SMF to enable the pause of charging
Operator specified criteria/threshold (e.g. number/fraction of packets/bytes dropped at UPF in downlink since last time the N3 tunnel towards the AN was released). The SMF requests the UPF to notify the SMF whenever the criteria/threshold is met.
Indication of “Radio Link Failure” (see clause 4.2.6 of 3GPP TS 23.502 V16.7.1).

Based on operator policies, if the trigger for the SMF to enable the pause of charging is met, the SMF shall pause the charging. When the SMF pauses charging the following applies:
Towards the UPF(s) where the Usage Reporting is configured, the SMF shall modify the Usage Reporting Rules for the PDU Session so that the usage collection for charging is stopped.
The SMF may request the UPF to limit the rate of downlink traffic sent to the downstream UPF or the AN.

In home routed roaming scenarios, based on operator's policy, the H-SMF (home SMF) may indicate to the V-SMF (visited SMF) if the feature is to be enabled on a per PDU (Protocol Data Unit) Session basis. This is indicated to the V-SMF by a “PDU Session Charging Pause Enabled” Indication in the Nsmf_PDUSession_Create Response during the PDU Session Establishment procedure. This is an indication to the V-SMF that when the criteria for pause of SMF charging are met at the VPLMN (Visited Public Land Mobile Network) charging at the H-SMF can be paused.

The H-SMF shall stop any charging and usage monitoring actions for the PDU Session upon receiving a “Start Pause of Charging” Indication in a Nsmf_PDUSession_Update request from the V-SMF. When the H-SMF receives a Nsmf_PDUSession_Update request for a PDU Session with a “Stop Pause of Charging” Indication, then the H-SMF shall resume charging for the PDU Session.

When the (V-)SMF receives a Nsmf_PDUSession_UpdateSMContext request or a Namf_EventExposure_Notify about UE reachability, the (V-)SMF shall consider the PDU Session charging as being unpaused if it had been paused previously.

FIG. 1 shows a flowchart of SMF Pause of charging procedure. FIG. 1 is same as FIG. 4.4.4-1 of 3GPP TS 23.502 V16.7.1. The steps of FIG. 1 have been described in clause 4.4.4 of 3GPP TS 23.502V16.7.1.

At step 1. The UPF receives downlink data packets for a PDU Session that does not have an N3 tunnel and the UPF sends data notification to the SMF. The packets are buffered or discarded in the UPF based on operator policy.

At step 2. Based on operator policy/configuration the SMF triggers the procedure to pause PDU Session charging. Triggering criteria are based on SMF operator policy/configuration.

At step 3. SMF sends a N4 Session Modification Request message to the UPF where the Usage Reporting is configured, modifying the Usage Reporting Rules for the PDU Session so that the usage collection for charging is stopped. In home routed roaming scenarios, the V-SMF sends a Nsmf_PDUSession_Update request to the H-SMF with a “Start Pause of Charging” Indication. The H-SMF then requests the H-UPF to stop usage collection as mentioned before.

At step 4. UPF confirms with a N4 Session Modification Response message.

3GPP TS 23.401 V16.9.0, the disclosure of which is incorporated by reference herein in their entirety, has described PDN GW Pause of Charging procedure. As described in clause of 3GPP TS 23.401 V16.9.0, the PDN GW Pause of Charging procedure is optionally supported by the Serving GW and PDN GW and has the purpose to limit a mismatch between PDN GW and Serving GW charging volume and packet counts. Generally, it aims for the PDN GW charging and usage monitoring data to more accurately reflect the downlink traffic actually sent to the E-UTRAN (Evolved Universal Terrestrial Radio Access Network).

FIG. 2 shows a flowchart of PDN GW Pause of charging procedure. FIG. 2 is same as FIG. 5.3.6A of 3GPP TS 23.401 V16.9.0. The steps of FIG. 2 have been described in clause of 3GPP TS 23.401 V16.9.0.

At step 1. The Serving GW receives downlink data packets for a UE known as not user plane connected (i.e. the Serving GW context data indicates no downlink user plane TED (Tunnel Endpoint Identifier) for the eNodeB) as described in clause 5.3.4.3 step 1 of 3GPP TS 23.401 V16.9.0, i.e. the packets are buffered or discarded in Serving GW based on operator policy.

At step 2. Based on operator policy/configuration the Serving GW triggers the procedure to pause PDN charging. Triggering criteria are based on Serving GW operator policy/configuration. Example of such policy may be:
a. Operator specified criteria/threshold (e.g. number/fraction of packets/bytes dropped at Serving GW in downlink since last time the UE was in ECM-CONNECTED state (or for ISR (Idle mode Signalling Reduction) case PMM-CONNECTED state)).
b. Recent indication of “Abnormal Release of Radio Link” (see clause 5.3.5) or a recent Downlink Data Notification Reject (clause 5.3.4.3) without UE shortly re-entering ECM-CONNECTED state (or for ISR case without also re-entering PMM-CONNECTED state).

At step 3. Serving GW sends a Modify Bearer Request (PDN Charging Pause Start) message to the PDN GW. PDN Charging Pause Start indicates that PDN GW charging shall be paused.

At step 4. PDN GW confirms with a Modify Bearer Response message.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

There may be some problems in the prior art of charging procedure. For example, when the UPF detects that the discarding threshold is reached, this time point should be the exactly time point of pausing of charging. However as defined in 3GPP TS 23.502 V16.7.1 and 3GPP TS 23.401 V16.9.0, a UP (user plane) needs to send a report to a CP (control plane), and the CP needs to send information regarding start of pause of charging to a peer CP. The peer CP sends an N4 message to instruct a peer UP to pause charging. During the transferring time of 2 PFCP message transferring times plus transferring time between CP functions plus additional processing time (to handle PFCP, or GTPv2 (General Packet Radio Service Tunneling Protocol version 2) for EPS (Evolved Packet System) or HTTP (Hyper Text Transfer Protocol) message for 5GC (5G core network)), there may be more discarded data (for example for MBB (Mobile Broadband) service). But actually the discarded data during the transferring time are already charged by the peer CP. The discarded data shall not be charged since it is discarded in the UP. This charging procedure may cause over-charged problem and may lead to un-satisfaction of the network operator and/or the user.

This “over-charging” problem may be applied in various scenarios, such as 4G CUPS with SGW-C and PGW-C, 5G Roaming with V-SMF and H-SMF, 5G with I-SMF (intermediate SMF) and I-UPF (intermediate UPF) inserted, 5G with I-UPF inserted and without I-SMF inserted, etc.

FIG. 3 shows an example of overcharging problem for pause of charging in a scenario of 5G roaming.

At step 1, when the dropped packets reached a threshold at a time point T1 (the time point starting drop packets), V-UPF may send a PFCP Session Report Request (Usage Report Trigger (DROTH (Dropped DL Traffic Threshold)) to V-SMF.

At step 2, V-SMF may send a PFCP Session Report Response to V-UPF.

At step 3, V-SMF may send an Nsmf_PDUSession_Update request (Start Pause of Charging” Indication) to H-SMF.

At step 4, H-SMF may send an Nsmf_PDUSession_Update Response to V-SMF.

At step 5, H-SMF may send a PFCP Session Modification Request (Inactive Measurement Flag=1) to H-UPF. At a time point T2 (the time point starting pausing charging), the H-UPF may pause the charging.

At step 6, H-UPF may send a PFCP Session Modification Response to H-SMF.

The problem is that the packets sent during the time interval of T2−T1 (T2 subtract T1) are charged by H-SMF while dropped by V-UPF, these packets are overcharged.

FIG. 4 shows an example of overcharging problem for pause of charging in a scenario of I-SMF and I-UPF inserted in 5G.

At step 1, when the dropped packets reached a threshold at a time point T1 (the time point starting drop packets), I-UPF may send a PFCP Session Report Request (Usage Report Trigger (DROTH) to I-SMF.

At step 2, I-SMF may send a PFCP Session Report Response to I-UPF.

At step 3, I-SMF may send an Nsmf_PDUSession_Update request (Start Pause of Charging” Indication) to A-SMF (anchor SMF).

At step 4, A-SMF may send an Nsmf_PDUSession_Update Response to I-SMF.

At step 5, A-SMF may send a PFCP Session Modification Request (Inactive Measurement Flag=1) to A-UPF (anchor UPF). At a time point T2 (the time point starting pausing charging), the A-UPF may pause the charging.

At step 6, A-UPF may send a PFCP Session Modification Response to A-SMF.

The problem is that the packets sent during the time interval of T2−T1 (T2 subtract T1) are charged by A-SMF while dropped by I-UPF, these packets are overcharged.

FIG. 5 shows an example of overcharging problem for pause of charging in a scenario of I-UPF inserted and without I-SMF in 5G.

At step 1, when the dropped packets reached a threshold at a time point T1 (the time point starting drop packets), I-UPF may send a PFCP Session Report Request (Usage Report Trigger (DROTH) to SMF.

At step 2, SMF may send a PFCP Session Report Response to I-UPF.

At step 3, SMF may send a PFCP Session Modification Request (Inactive

Measurement Flag=1) to A-UPF. At a time point T2 (the time point starting pausing charging), the A-UPF may pause the charging.

At step 4, A-UPF may send a PFCP Session Modification Response to SMF.

The problem is that the packets sent during the time interval of T2−T1 (T2 subtract T1) are charged by SMF while dropped by I-UPF, these packets are overcharged.

The messages of FIGS. 3-5 are similar to the corresponding messages as described in 3GPP TS 29.244 V16.6.0.

FIG. 6 shows an example of overcharging problem for pause of charging in a scenario of 4G CUPS.

At step 1, when the dropped packets reached a threshold at a time point T1 (the time point starting drop packets), SGW-U may send a PFCP Session Report Request (Usage Report Trigger (DROTH) to SGW-C.

At step 2, SGW-C may send a PFCP Session Report Response to SGW-U.

At step 3, SGW-C may send a Modify Bearer Request (Indication Flags\PDN Pause On Indication) to PGW-C.

At step 4, PGW-C may send a Modify Bearer Response to SGW-C.

At step 5, PGW-C may send a PFCP Session Modification Request (Inactive Measurement Flag=1) to PGW-U. At a time point T2 (the time point starting pausing charging), PGW-U may pause the charging.

At step 6, PGW-U may send a PFCP Session Modification Response to PGW-C.

The problem is that the packets sent during the time interval of T2−T1 (T2 subtract T1) are charged by PGW-C while dropped by SGW-U, these packets are overcharged.

More DL data packets will be charged in the PGW-U or PSA UPF while the packets will be deemed discarded in the SGW-U and I/V-UPF, this leads much bigger charging discrepancy, especially considering eMBB (Enhanced MBB) services with large band-width.

Ideally the PGW-U and PSA UPF should be notified at the exact time point when the SGW-U, I/V-UPF is reaching the Dropped DL Traffic Threshold.

The messages of FIG. 6 are similar to the corresponding messages as described in 3GPP TS 23.214 V16.2.0.

To overcome or mitigate at least one of above mentioned problems or other problems, the embodiments of the present disclosure propose an improved solution for charging management.

In a first aspect of the disclosure, there is provided a method performed by a first user plane function. The method comprises determining a charging action for a first session. The method further comprises sending information regarding the charging action for the first session to a second user plane function.

In an embodiment, the method further comprises receiving an acknowledgement for the information regarding the charging action for the first session from the second user plane function.

In an embodiment, the information regarding the charging action for the first session is comprised in a general packet radio service tunnelling protocol for user plane (GTP-U) tunnel status message and the acknowledgement for the information regarding the charging action for the first session is comprised in another GTP-U tunnel status message.

In an embodiment, the charging action is determined based on at least one of an operator policy, or an operator configuration.

In an embodiment, sending information regarding the charging action for the first session to a second user plane function comprises immediately sending the information regarding the charging action for the first session to the second user plane function after determining the charging action for the first session.

In an embodiment, the charging action comprises immediate start of pause of charging.

In an embodiment, the method further comprises receiving, from a control plane function, an indication for sending information regarding a charging action for a second session to another user plane function after determining the charging action for the second session.

In an embodiment, the indication is comprised in at least one of a packet forwarding control protocol (PFCP) session establishment request or a PFCP session modification request.

In an embodiment, the method further comprises sending a supported feature of the first user plane function to a control plane function. The supported feature of the first user plane function indicates that the first user plane function supports sending and/or receiving information regarding a charging action for a session to and/or from another user plane function.

In an embodiment, the supported feature of the first user plane function is comprised in a packet forwarding control protocol (PFCP) association setup response or request.

In an embodiment, the control plane function comprises at least one of a packet data network control plane (PGW-C), a serving gateway control plane (SGW-C), or a session management function (SMF).

In an embodiment, the first user plane function comprises at least one of a serving gateway user plane (SGW-U), a visited user plane function (V-UPF); or an intermediate user plane function (I-UPF).

In an embodiment, the second user plane function comprises at least one of a packet data network user plane (PGW-U), an intermediate user plane function (I-UPF), a home user plane function (H-UPF), or an anchor user plane function (A-UPF).

In a second aspect of the disclosure, there is provided a method performed by a second user plane function. The method comprises receiving information regarding a charging action for a first session from a first user plane function. The method further comprises performing the charging action for the first session based on the information regarding the charging action for the first session.

In an embodiment, the method further comprises sending an acknowledgement for the information regarding the charging action for the first session to the first user plane function.

In an embodiment, performing the charging action for the first session based on the information regarding the charging action for the first session comprises immediately performing the charging action for the first session based on the information regarding the charging action for the first session after receiving the information regarding the charging action for the first session from a first user plane function.

In an embodiment, the method further comprises receiving, from a control plane function, an indication of whether a usage reporting rule is applicable for a charging action received from another user plane function.

In an embodiment, the method further comprises sending a supported feature of the second user plane function to a control plane function. The supported feature of the second user plane function indicates that the second user plane function supports sending and/or receiving information regarding a charging action for a session to and/or from another user plane function.

In an embodiment, the supported feature of the second user plane function is comprised in a packet forwarding control protocol (PFCP) association setup response or request.

In a third aspect of the disclosure, there is provided a method performed by a first control plane function. The method comprises receiving a supported feature of a user plane function from a user plane function. The supported feature of the user plane function indicates that the user plane function supports sending and/or receiving information regarding a charging action for a session to and/or from another user plane function.

In an embodiment, the method further comprises sending, to the user plane function, an indication for sending information regarding a charging action for a session to another user plane function after determining the charging action for the session.

In an embodiment, the method further comprises sending a supported feature of the first control plane function to a second control plane function. The supported feature of the first control plane function indicates that the first control plane function supports to configure a user plane function to send and/or receive information regarding a charging action for a session to and/or from another user plane function.

In an embodiment, the method further comprises receiving a supported feature of a second control plane function from the second control plane function. The supported feature of the second control plane function indicates that the second control plane function supports to configure a user plane function to send and/or receive information regarding a charging action for a session to and/or from another user plane function.

In an embodiment, the supported feature of the first control plane function is comprised in a session create request. The supported feature of the second control plane function is comprised in a session create response.

In a fourth aspect of the disclosure, there is provided a first user plane function. The first user plane function comprises a processor and a memory coupled to the processor. Said memory contains instructions executable by said processor. Said first user plane function is operative to determine a charging action for a first session. Said first user plane function is further operative to send information regarding the charging action for the first session to a second user plane function.

In a fifth aspect of the disclosure, there is provided a second user plane function. The second user plane function comprises a processor and a memory coupled to the processor. Said memory contains instructions executable by said processor. Said second user plane function is operative to receive information regarding a charging action for a first session from a first user plane function. Said second user plane function is further operative to perform the charging action for the first session based on the information regarding the charging action for a session.

In a sixth aspect of the disclosure, there is provided a first control plane function. The first control plane function comprises a processor and a memory coupled to the processor. Said memory contains instructions executable by said processor. Said first control plane function is operative to receive a supported feature of a user plane function from a user plane function. The supported feature of the user plane function indicates that the user plane function supports sending and/or receiving information regarding a charging action for a session to and/or from another user plane function.

In a seventh aspect of the disclosure, there is provided a first user plane function. The first user plane function comprises a determining module and a first sending module. The determining module is configured to determine a charging action for a first session. The first sending module is configured to send information regarding the charging action for the first session to a second user plane function.

In an embodiment the first user plane function further comprises a first receiving module configured to receive an acknowledgement for the information regarding the charging action for the first session from the second user plane function.

In an embodiment the first user plane function further comprises a second receiving module configured to receive, from a control plane function, an indication for sending information regarding a charging action for a second session to another user plane function after determining the charging action for the second session.

In an embodiment the first user plane function further comprises a second sending module configured to send a supported feature of the first user plane function to a control plane function. The supported feature of the first user plane function indicates that the first user plane function supports sending and/or receiving information regarding a charging action for a session to and/or from another user plane function.

In an eighth aspect of the disclosure, there is provided a second user plane function. The second user plane function comprises a first receiving module and a performing module. The first receiving module is configured to receive information regarding a charging action for a first session from a first user plane function. The performing module is configured to perform the charging action for the first session based on the information regarding the charging action for the first session.

In an embodiment the second user plane function further comprises a first sending module configured to send an acknowledgement for the information regarding the charging action for the first session to the first user plane function.

In an embodiment the second user plane function further comprises a second receiving module configured to receive, from a control plane function, an indication of whether a usage reporting rule is applicable for a charging action received from another user plane function.

In an embodiment the second user plane function further comprises a second sending module configured to send a supported feature of the second user plane function to a control plane function. The supported feature of the second user plane function indicates that the second user plane function supports sending and/or receiving information regarding a charging action for a session to and/or from another user plane function.

In a ninth aspect of the disclosure, there is provided a first control plane function. The first control plane function comprises a first receiving module. The first receiving module is configured to receive a supported feature of a user plane function from a user plane function. The supported feature of the user plane function indicates that the user plane function supports sending and/or receiving information regarding a charging action for a session to and/or from another user plane function.

In an embodiment the first control plane function further comprises a first sending module configured to send, to the user plane function, an indication for sending information regarding a charging action for a session to another user plane function after determining the charging action for the session.

In an embodiment the first control plane function further comprises a second sending module configured to send a supported feature of the first control plane function to a second control plane function. The supported feature of the first control plane function indicates that the first control plane function supports to configure a user plane function to send and/or receive information regarding a charging action for a session to and/or from another user plane function.

In an embodiment the first control plane function further comprises a second receiving module configured to receive a supported feature of a second control plane function from the second control plane function. The supported feature of the second control plane function indicates that the second control plane function supports to configure a user plane function to send and/or receive information regarding a charging action for a session to and/or from another user plane function.

In a tenth aspect of the disclosure, there is provided a computer program product comprising instructions which, when executed on at least one processor, cause the at least one processor to perform any of the methods according to according to the first, second and third aspects of the disclosure.

In a eleventh aspect of the disclosure, there is provided a computer-readable storage medium storing instructions which, when executed on at least one processor, cause the at least one processor to perform any of the methods according to according to the first, second and third aspects of the disclosure.

Embodiments herein afford many advantages, of which a non-exhaustive list of examples follows. Some embodiments herein may solve the over-charging problem of pause of charging in at least one of scenarios: 4G CUPS with SGW-C and PGW-C, 5G Roaming with V-SMF and H-SMF, 5G with I-SMF and I-UPF inserted, and 5G with I-UPF inserted and without I-SMF inserted. Some embodiments herein may increase the network quality. Some embodiments herein may improve the operator's satisfaction. Some embodiments herein may improve the user's satisfaction. The embodiments herein are not limited to the features and advantages mentioned above. A person skilled in the art will recognize additional features and advantages upon reading the following detailed description..

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 shows a flowchart of SMF Pause of charging procedure;

FIG. 2 shows a flowchart of PDN GW Pause of charging procedure;

FIG. 3 shows an example of overcharging problem for pause of charging in a scenario of 5G roaming;

FIG. 4 shows an example of overcharging problem for pause of charging in a scenario of I-SMF and I-UPF inserted in 5G;

FIG. 5 shows an example of overcharging problem for pause of charging in a scenario of I-UPF inserted and without I-SMF in 5G;

FIG. 6 shows an example of overcharging problem for pause of charging in a scenario of 4G CUPS;

FIG. 7 schematically shows a high level architecture of CUPS in the fourth generation network;

FIG. 8 schematically shows a high level architecture in the fifth generation network according to an embodiment of the present disclosure;

FIG. 9 shows a flowchart of a method according to an embodiment of the present disclosure;

FIG. 10 shows a flowchart of a method according to another embodiment of the present disclosure;

FIG. 11 shows a flowchart of a method according to another embodiment of the present disclosure;

FIG. 12 shows a flowchart of a method according to another embodiment of the present disclosure;

FIG. 13 shows a flowchart of a method according to another embodiment of the present disclosure;

FIG. 14 shows a flowchart of a method according to another embodiment of the present disclosure;

FIG. 15 shows a flowchart of solution for solving overcharging problem in a scenario of 5G roaming according to an embodiment of the present disclosure;

FIG. 16 shows a flowchart of solution for solving overcharging problem in a scenario of I-SMF and I-UPF inserted in 5G according to an embodiment of the present disclosure;

FIG. 17 shows a flowchart of solution for solving overcharging problem in a scenario of I-UPF inserted and without I-SMF inserted in 5G according to an embodiment of the present disclosure;

FIG. 18 shows a flowchart of solution for solving overcharging problem in a scenario of 4G CUPS according to an embodiment of the present disclosure;

FIG. 19 is a block diagram showing an apparatus suitable for use in practicing some embodiments of the disclosure;

FIG. 20 illustrates a simplified block diagram of a first user plane function according to an embodiment of the present disclosure;

FIG. 21 illustrates a simplified block diagram of a second user plane function according to an embodiment of the present disclosure; and

FIG. 22 illustrates a simplified block diagram of a first control plane function according to an embodiment of the present disclosure.

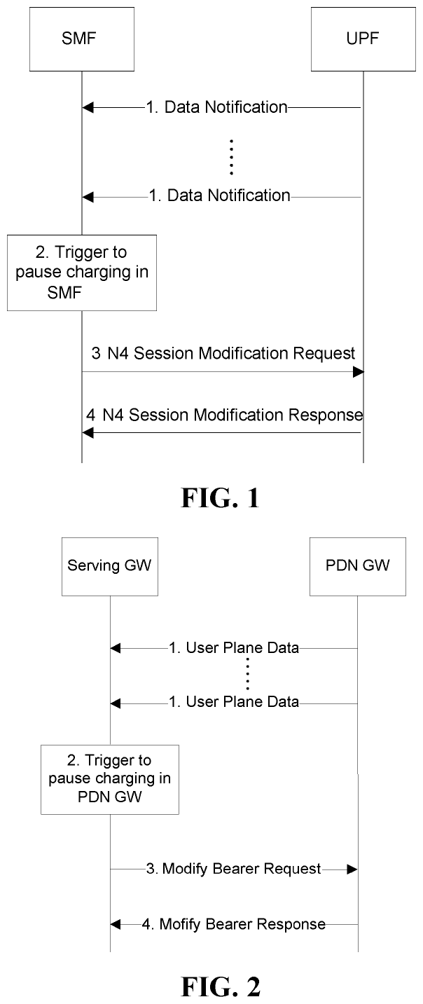

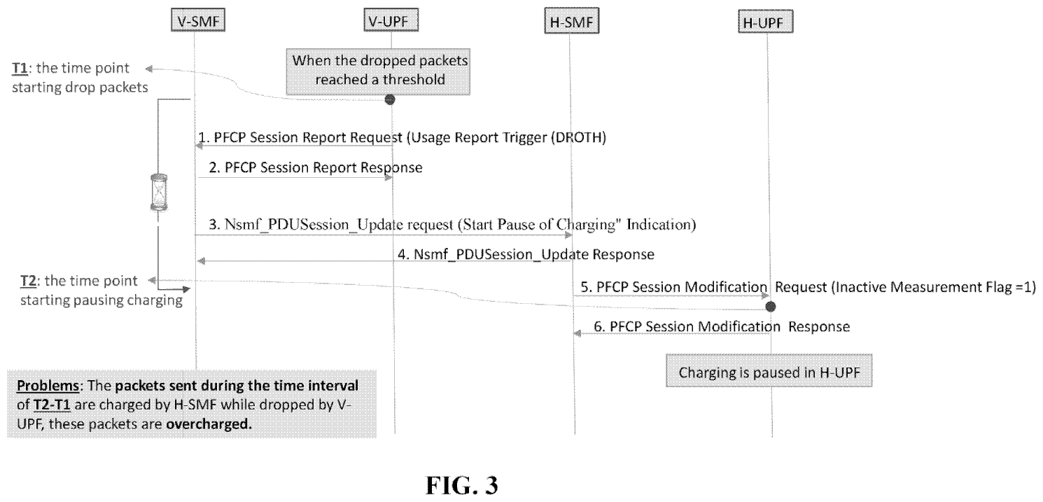

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable wireless communication standards such as new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3GPP. For example, the communication protocols as may comprise the first generation (1G), 2G, 3G, 4G, 4.5G, 5G communication protocols, and/or any other protocols either currently known or to be developed in the future.

The term “network device” or “network node” used herein refers to a network entity such as a core network device in a communication network. For example, in a wireless communication network such as a 3GPP-type cellular network, the network node may comprise a control plane function (e.g., SMF, PGW-C, TDF-C and SGW-C) and a user plane function (e.g., UPF, PGW-U, TDF-U and SGW-U), etc., which may offer numerous services to customers who are interconnected by an access network device. Each access network device is connectable to the core network device over a wired or wireless connection.

The term “network function (NF)” refers to any suitable function which can be implemented in a network node (physical or virtual) such as a core network node of a communication network. For example, the 5G system (5GS) may comprise a plurality of NFs such as AMF (Access and mobility Function), SMF (Session Management Function), AUSF (Authentication Service Function), UDM (Unified Data Management), PCF (Policy Control Function), AF (Application Function), NEF (Network Exposure Function), UPF (User plane Function) and NRF (NF Repository Function), RAN (radio access network), SCP (service communication proxy), etc. In other embodiments, the network function may comprise different types of NFs for example depending on a specific type of network.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VoIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP, such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IOT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/ or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

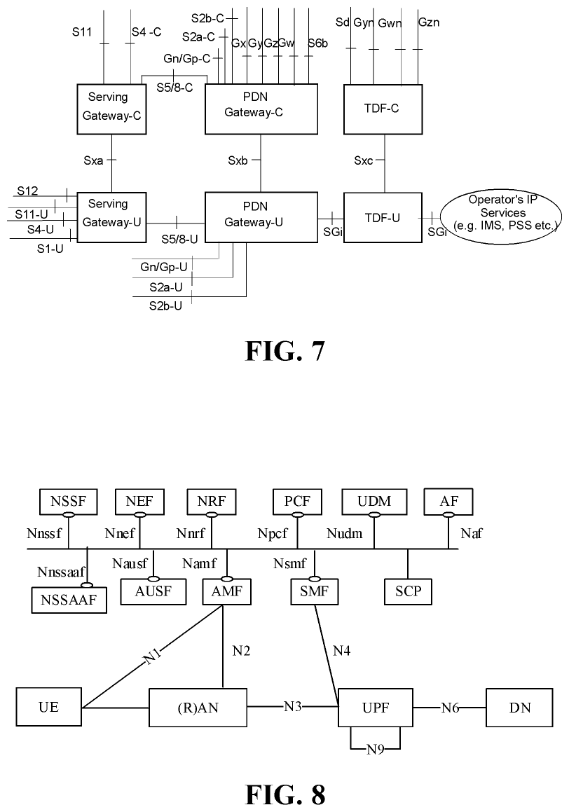

Although the subject matter described herein may be implemented in any appropriate type of system using any suitable components, the embodiments disclosed herein are described in relation to a communication system complied with the exemplary system architecture illustrated in FIG. 7 and FIG. 8. For simplicity, the system architectures of FIGS. 7-8 only depict some exemplary elements. In practice, a communication system may further include any additional elements suitable to support communication between terminal devices or between a wireless device and another communication device, such as a landline telephone, a service provider, or any other network node or terminal device. The communication system may provide communication and various types of services to one or more terminal devices to facilitate the terminal devices' access to and/or use of the services provided by, or via, the communication system.

FIG. 7 schematically shows a high level architecture of CUPS in the fourth generation network. The system architecture of FIG. 7 may be same as the Architecture reference model as described in clause 4.2 of 3GPP TS 23.214 V16.2.0 and may comprise some exemplary network nodes such as serving gateway-C (SGW-C), serving gateway-U (SGW-U), PDN gateway-C (PGW-C), PDN gateway-U (PGW-U), TDF-C and TDF-U. As further illustrated in FIG. 7, the exemplary system architecture also contains the some interfaces such as Sxa. Sxb, Sxc, etc. Various network nodes shown in FIG. 7 may be responsible for functions for example as defined in 3GPP TS 23.214 V16.2.0. Each PGW-C may manage/control one or more PGW-Us though only one PGW-U is shown in the system. Each SGW-C may manage/control multiple SGW-Us though only one SGW-U is shown in the system. Each TDF-C may manage/control multiple TDF-Us though only one TDF-U is shown in the system.

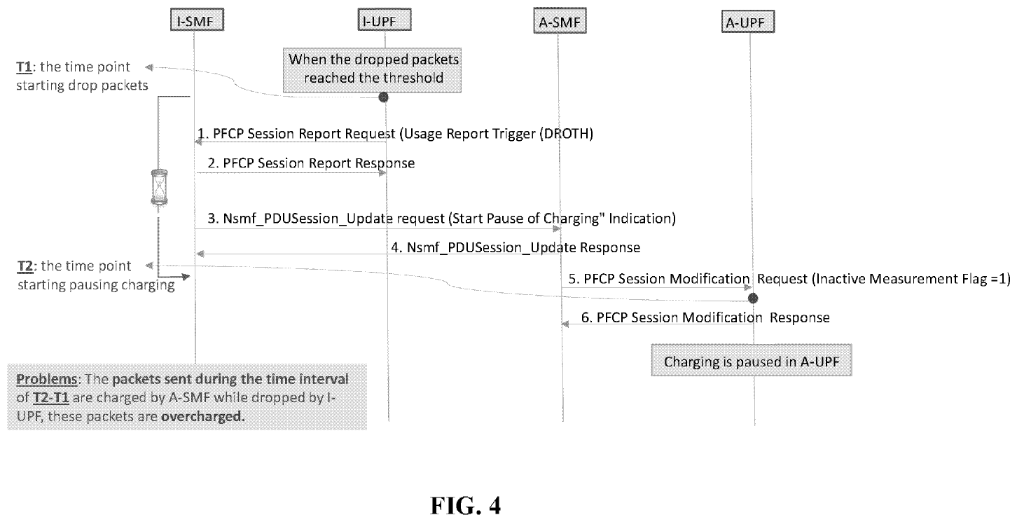

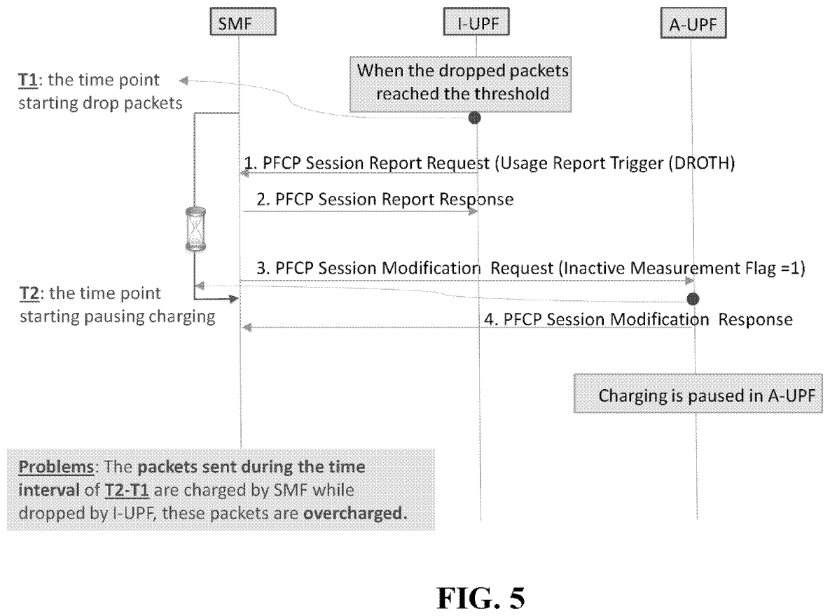

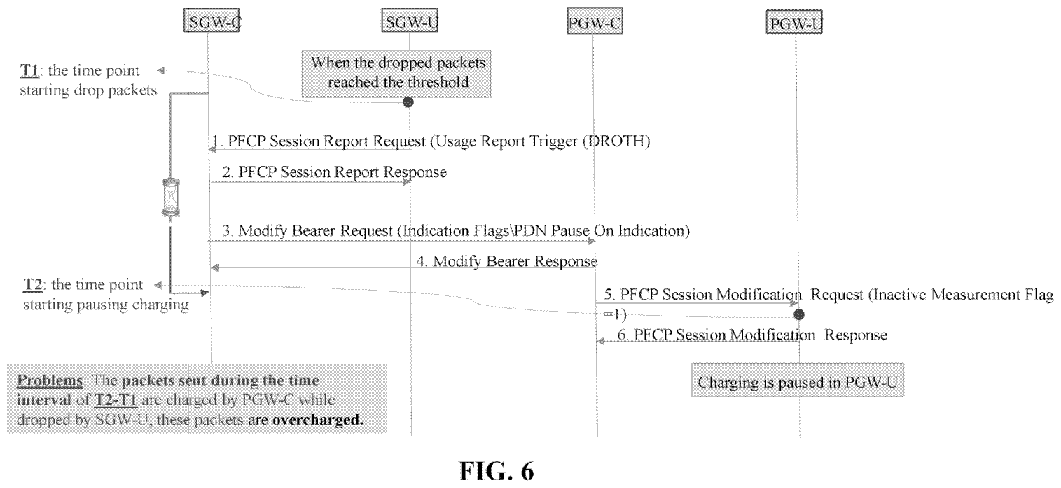

FIG. 8 schematically shows a high level architecture in the fifth generation network according to an embodiment of the present disclosure. For example, the fifth generation network may be 5GS (5G system). The architecture of FIG. 8 is same as FIG. 4.2.3-1 as described in 3GPP TS 23.501 V16.7.0, the disclosure of which is incorporated by reference herein in its entirety. The system architecture of FIG. 8 may comprise some exemplary elements such as AUSF, AMF, DN (data network), NEF, NRF, NSSF, PCF, SMF, UDM, UPF, AF, UE, (R)AN, SCP (Service Communication Proxy), NSSAAF (Network Slice-Specific Authentication and Authorization Function), etc.

In accordance with an exemplary embodiment, the UE can establish a signaling connection with the AMF over the reference point N1, as illustrated in FIG. 8. This signaling connection may enable NAS (Non-access stratum) signaling exchange between the UE and the core network, comprising a signaling connection between the UE and the (R)AN and the N2 connection for this UE between the (R)AN and the AMF. The (R)AN can communicate with the UPF over the reference point N3. The UE can establish a protocol data unit (PDU) session to the DN (data network, e.g. an operator network or Internet) through the UPF over the reference point N6.

As further illustrated in FIG. 8, the exemplary system architecture also contains the service-based interfaces such as Nnrf, Nnef, Nausf, Nudm, Npcf, Namf and Nsmf exhibited by NFs such as the NRF, the NEF, the AUSF, the UDM, the PCF, the AMF and the SMF. In addition, FIG. 8 also shows some reference points such as N1, N2, N3, N4, N6 and N9, which can support the interactions between NF services in the NFs. For example, these reference points may be realized through corresponding NF service-based interfaces and by specifying some NF service consumers and providers as well as their interactions in order to perform a particular system procedure.

Various NFs shown in FIG. 8 may be responsible for functions such as session management, mobility management, authentication, security, etc. The AUSF, AMF, DN, NEF, NRF, NSSF, PCF, SMF, UDM, UPF, AF, UE, (R)AN, SCP may include the functionality for example as defined in clause 6.2 of 3GPP TS23.501 V16.7.0.

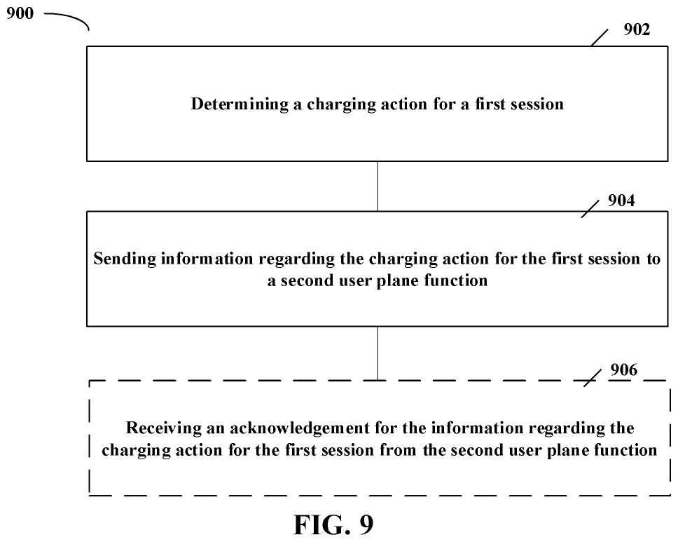

FIG. 9 shows a flowchart of a method according to an embodiment of the present disclosure, which may be performed by an apparatus implemented in/as or communicatively coupled to a first user plane function. As such, the apparatus may provide means or modules for accomplishing various parts of the method 900 as well as means or modules for accomplishing other processes in conjunction with other components.

At block 902, the first user plane function may determine a charging action for a first session. The first session may be any suitable session for example as described in various 3GPP specifications such as 3GPP TS23.501 V16.7.0, 3GPP TS 23.401 V16.9.0, etc. In an embodiment, the first session may be a PDU session or a IP-CAN (Internet Protocol-Connectivity Access Network) session. The first user plane function may be any suitable entity or node which can implement the user plane function. In an embodiment, the first user plane function may be a serving gateway user plane (SGW-U), a visited user plane function (V-UPF), an intermediate user plane function (I-UPF), etc.

The charging action may be any suitable charging action such as start charging, pause charging, stop charging, cancel charging, etc. In an embodiment, the charging action comprises immediate start of pause of charging.

The first user plane function may determine the charging action for the first session when some condition or policy or configuration is met. In an embodiment, the charging action is determined based on at least one of an operator policy or an operator configuration. For example, the following are example triggers for the first user plane function to determine the charging action such as pause of charging:
Operator specified criteria/threshold (e.g. number/fraction of packets/bytes dropped at UPF in downlink since last time the N3 tunnel towards the AN was released). Whenever the criteria/threshold related to the first session is met, the first user plane function may determine a charging action such as pause of charging.
Indication of Radio Link Failure. Whenever the first user plane function knows radio link failure related to the first session, the first user plane function may determine a charging action such as pause of charging.

At block 904, the first user plane function may send information regarding the charging action for the first session to a second user plane function. The second user plane function may be any suitable entity or node which can implement the user plane function. In an embodiment, the first user plane function may be a packet data network user plane (PGW-U), a home user plane function (H-UPF), or an anchor user plane function (A-UPF, or also called PDU Session Anchor (PSA) UPF), etc.

In an embodiment, the first user plane function may be a user plane function close to the UE or RAN and the second user plane function may be a user plane function close to the data network. In an embodiment, the first user plane function may be a user plane function closer to the UE or RAN than the second user plane function.

The information regarding the charging action for the first session may be comprised in an suitable message (such as an existing message or a new message) that can be transmitted between the first user plane function and the second user plane function.

In an embodiment, the information regarding the charging action for the first session is comprised in a general packet radio service tunnelling protocol for user plane (GTP-U) tunnel status message.

In an embodiment, the first user plane function immediately send the information regarding the charging action for the first session to the second user plane function after determining the charging action for the first session.

At block 906, optionally, the first user plane function may receive an acknowledgement for the information regarding the charging action for the first session from the second user plane function.

The acknowledgement for the information regarding the charging action for the first session may be comprised in an suitable message (such as an existing message or a new message) that can be transmitted between the first user plane function and the second user plane function. In an embodiment, the acknowledgement for the information regarding the charging action for the first session is comprised in another GTP-U tunnel status message such as GTP-U tunnel status acknowledgement message.

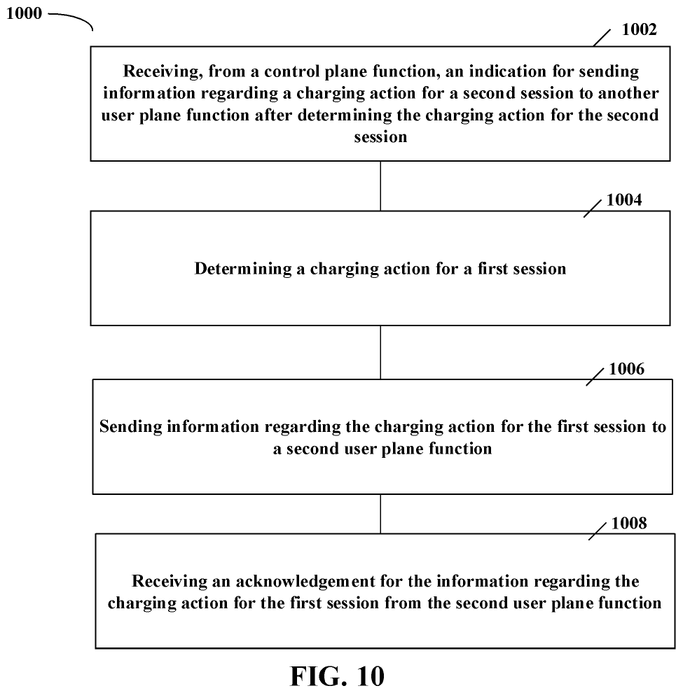

FIG. 10 shows a flowchart of a method according to another embodiment of the present disclosure, which may be performed by an apparatus implemented in/as or communicatively coupled to a first user plane function. As such, the apparatus may provide means or modules for accomplishing various parts of the method 1000 as well as means or modules for accomplishing other processes in conjunction with other components. For some parts which have been described in the above embodiments, the description thereof is omitted here for brevity.

At block 1002, the first user plane function may receive, from a control plane function, an indication for sending information regarding a charging action for a second session to another user plane function after determining the charging action for the second session. The second session may be any suitable session for example as described in various 3GPP specifications such as 3GPP TS23.501 V16.7.0, 3GPP TS 23.401 V16.9.0, etc. In an embodiment, the second session may be a PDU session or a IP-CAN session. In an embodiment, the second session may be the same as the first session. The control plane function can send this indication for a single session or a group of sessions or all sessions controlled by the first user plane function.

The control plane function may be any suitable entity or node which can implement the control plane function. In an embodiment, the control plane function may be a packet data network control plane (PGW-C), a serving gateway control plane (SGW-C), or a session management function (SMF) as described in 3GPP TS 23.214 V16.2.0 and TS 29.244 V16.6.0. The SMF may be an intermediate SMF (I-SMF), anchor SMF (A-SMF), visited SMF (V-SMF), or home SMF (H-SMF), etc.

The indication may be comprised in an suitable message (such as an existing message or a new message) that can be transmitted between the first user plane function and the control plane function. In an embodiment, the indication is comprised in at least one of a packet forwarding control protocol (PFCP) session establishment request, a PFCP session modification request as described in 3GPP TS 29.244 V16.6.0, an Sx session establishment request, or an Sx session modification request as described in 3GPP TS 23.214 V16.2.0.

Blocks 1004, 1006 and 1008 are same as blocks 902, 904 and 906 of FIG. 9 respectively.

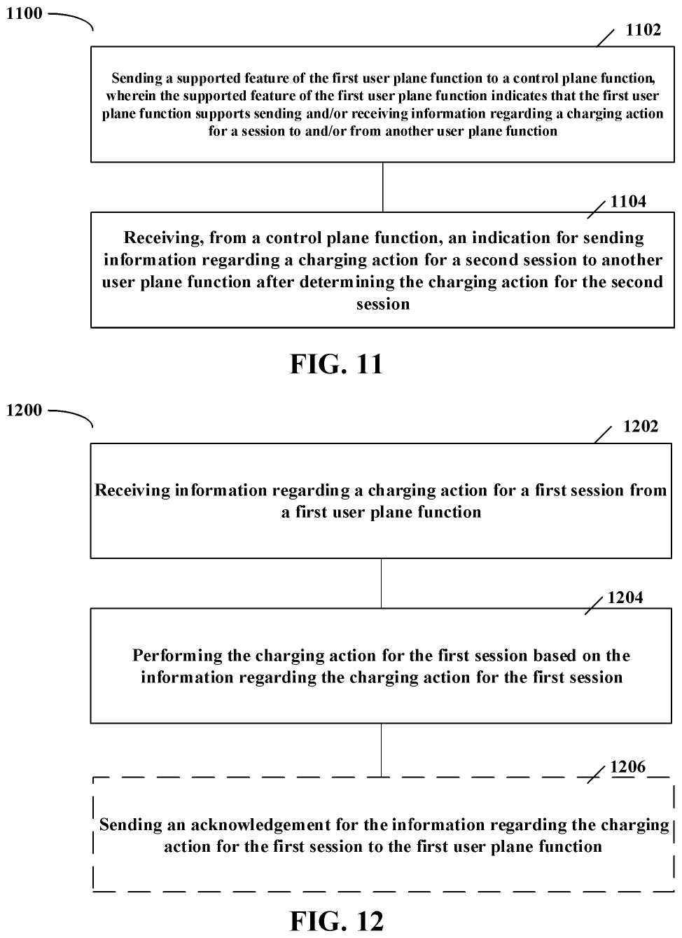

FIG. 11 shows a flowchart of a method according to another embodiment of the present disclosure, which may be performed by an apparatus implemented in/as or communicatively coupled to a first user plane function. As such, the apparatus may provide means or modules for accomplishing various parts of the method 1100 as well as means or modules for accomplishing other processes in conjunction with other components. For some parts which have been described in the above embodiments, the description thereof is omitted here for brevity.

At block 1102, the first user plane function may send a supported feature of the first user plane function to a control plane function. The supported feature of the first user plane function indicates that the first user plane function supports sending and/or receiving information regarding a charging action for a session to and/or from another user plane function.

The supported feature of the first user plane function may be comprised in an suitable message (such as an existing message or a new message) that can be transmitted between the first user plane function and the control plane function. In an embodiment, the supported feature of the first user plane function is comprised in a packet forwarding control protocol (PFCP) association setup response or request as described in 3GPP TS 29.244 V16.6.0.

At block 1104, the first user plane function may receive, from the control plane function, an indication for sending information regarding a charging action for a second session to another user plane function after determining the charging action for the second session. For example, when the control plane function knows that the first user plane function supports sending information regarding a charging action for a session to another user plane function, the control plane function may send this indication to the first user plane function.

FIG. 12 shows a flowchart of a method according to another embodiment of the present disclosure, which may be performed by an apparatus implemented in/as or communicatively coupled to a second user plane function. As such, the apparatus may provide means or modules for accomplishing various parts of the method 1200 as well as means or modules for accomplishing other processes in conjunction with other components. For some parts which have been described in the above embodiments, the description thereof is omitted here for brevity.

At block 1202, the second user plane function may receive information regarding a charging action for a first session from a first user plane function. For example the first user plane function may send the information regarding the charging action for the first session to the second user plane function at block 904 of FIG. 9, and then the second user plane function may receive the information regarding the charging action for the first session.

At block 1204, the second user plane function may perform the charging action for the first session based on the information regarding the charging action for the first session. For example, when the charging action is start charging, pause charging, stop charging, or cancel charging, the second user plane function may start charging, pause charging, stop charging, or cancel charging.

At block 1206, optionally, the second user plane function may send an acknowledgement for the information regarding the charging action for the first session to the first user plane function.

In an embodiment, the second user plane function may immediately perform the charging action for the first session based on the information regarding the charging action for the first session after receiving the information regarding the charging action for the first session from a first user plane function.

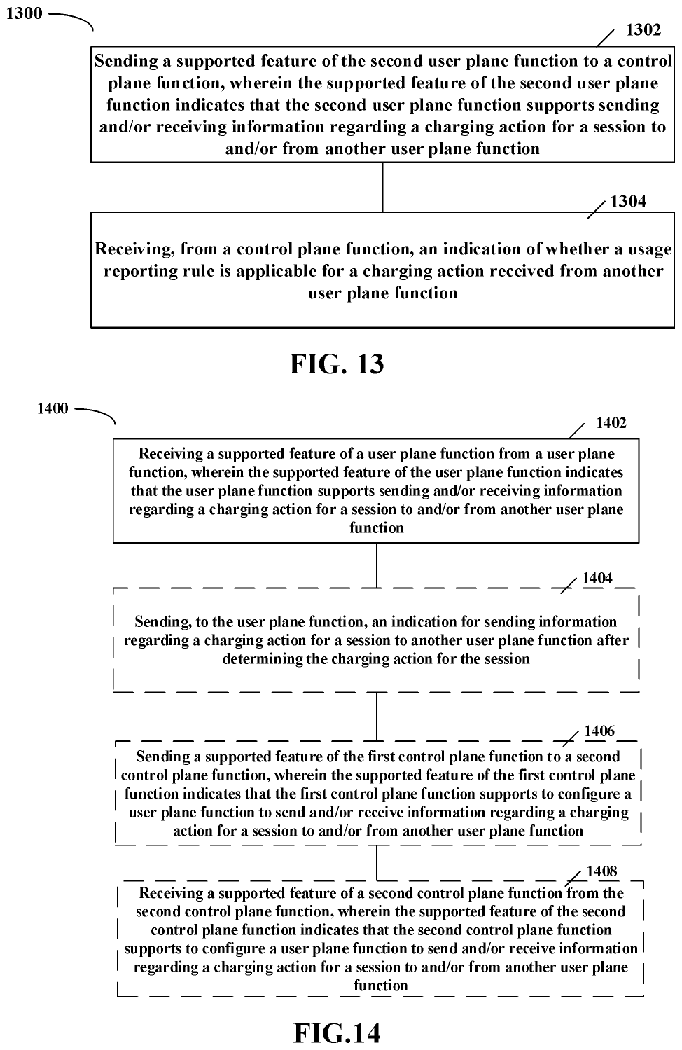

FIG. 13 shows a flowchart of a method according to another embodiment of the present disclosure, which may be performed by an apparatus implemented in/as or communicatively coupled to a second user plane function. As such, the apparatus may provide means or modules for accomplishing various parts of the method 1300 as well as means or modules for accomplishing other processes in conjunction with other components. For some parts which have been described in the above embodiments, the description thereof is omitted here for brevity. At block 1302, the second user plane function may send a supported feature of the

second user plane function to a control plane function. The supported feature of the second user plane function indicates that the second user plane function supports sending and/or receiving information regarding a charging action for a session to and/or from another user plane function. Block 1302 is similar to block 1102 of FIG. 11. The supported feature of the second user plane function is comprised in a packet forwarding control protocol (PFCP) association setup response or request.

At block 1304, the second user plane function may receive, from a control plane function, an indication of whether a usage reporting rule (URR) is applicable for a charging action received from another user plane function.. When the URR is applicable for a charging action received from another user plane function, the second user plane function may apply the URR. Otherwise the second user plane function may not apply the URR.

FIG. 14 shows a flowchart of a method according to another embodiment of the present disclosure, which may be performed by an apparatus implemented in/as or communicatively coupled to a first control plane function. As such, the apparatus may provide means or modules for accomplishing various parts of the method 1400 as well as means or modules for accomplishing other processes in conjunction with other components. For some parts which have been described in the above embodiments, the description thereof is omitted here for brevity.

At block 1402, the first control plane function may receive a supported feature of a user plane function from a user plane function. The supported feature of the user plane function indicates that the user plane function supports sending and/or receiving information regarding a charging action for a session to and/or from another user plane function.

At block 1404, optionally, the first control plane function may send, to the user plane function, an indication for sending information regarding a charging action for a session to another user plane function after determining the charging action for the session.

At block 1406, optionally, the first control plane function may send a supported feature of the first control plane function to a second control plane function. The supported feature of the first control plane function indicates that the first control plane function supports to configure a user plane function to send and/or receive information regarding a charging action for a session to and/or from another user plane function.

At block 1408, optionally, the first control plane function may receive a supported feature of a second control plane function from the second control plane function. The supported feature of the second control plane function indicates that the second control plane function supports to configure a user plane function to send and/or receive information regarding a charging action for a session to and/or from another user plane function.

The supported feature of the first control plane function may be comprised in an suitable message (such as an existing message or a new message) that can be transmitted between the first control plane function and the second control plane function. In an embodiment, the supported feature of the first control plane function may be comprised in a session create request. In an embodiment, the session create request may be an Nsmf_PDUSession_Create Request as described in 3GPP TS 23.502 V16.7.1 or Create Session Request as described in 3GPP TS 23.401 V16.9.0.

The supported feature of the second control plane function may be comprised in an suitable message (such as an existing message or a new message) that can be transmitted between the first control plane function and the second control plane function. In an embodiment, the supported feature of the second control plane function may be comprised in a session create response. In an embodiment, the session create response may be an Nsmf_PDUSession_Create Response as described in 3GPP TS 23.502 V16.7.1 or Create Session Response as described in 3GPP TS 23.401 V16.9.0.

In an embodiment, a new feature “Immediately start of pause of charging” is introduced. The UP Function (close to RAN) immediately sends a new GTP-U (general packet radio service tunnelling protocol for user plane) message with information to trigger the receiving UPF to stop measurement for the URRs (Usage Reporting Rule) which have “pause of charging applicable flag” is set to the remote upstream UPF when the dropped packets reached the threshold.

In an embodiment, the UP Function (e.g., SGW-U, PGW-U, I-UPF, PSA-UPF) may negotiate supporting the new feature “Immediately start of pause of charging” to CP function (e.g., SGW-C, PGW-C, I-SMF, Home-SMF, SMF) during the PFCP association setup procedure.

In an embodiment, during the PDU session establishment or modification procedure, the CP function (e.g. SGW-C, I-SMF) may provide an indication to the UP function to send, to an upstream UPF (e.g. I-UPF, or PSA UPF or PGW-U), a new GTP-U message, which may be called “GTP-U tunnel status info”, or an existing GTP-U message including a flag to trigger the receiving UPF to stop measurement for the URRs which have “pause of charging applicable flag” set to “1” when the dropped packets at the upstream UPF reaches the threshold. Said indication may be a flag, e.g. in Measurement Information, in the URR.

In an embodiment, during the PDU session establishment or modification procedure, the CP function (e.g., PGW-C, SMF and Home SMF) includes a new flag, which may be called “pause of charging applicable flag”, in a URR which is intended for pause of charging, so that the UP function may stop measurement for the URR if it receives a GTP-U message with an indication to indicate stopping measurement.

In an embodiment, the CP such as SGW-C, I-SMF, V-SMF may indicate a support of the new feature “Immediately start of pause of charging via user plane” when establishing a PDN connection/a PDU session towards the CP such as PGW-C, SMF and Home SMF if the UP such as SGW-U, I-UPF or V-UPF supports the new feature. The CP such as PGW-C, SMF, home SMF may confirm their support of the same new feature if the UP such as PGW-U, PSA UPF supports the new feature.

In an embodiment, between a first CP such as SGW-C and a second CP such as PGW-C, a new flag, which may be called “support of start pause of charging via user plane path”, is introduced over an interface (e.g., S5/S8) between the first CP and the second CP, e.g. in the

Indication IE (information element), or populated as a supported feature using Echo Request/Response, as a part of supported feature notification as specified in clause 11 of 3GPP TS 29.274 V17.0.0, the disclosures of which is incorporated by reference herein in its entirety.

In an embodiment, the UP such as UPF receives the DL data and triggers the DDN (downlink data notification) procedure, then the UP such as UPF starts to drop the packets due to slow paging response, and the dropped packets reached the threshold, the UP such as UPF immediately sends GTP-U Tunnel Status message with indicator: start of pause of charging to the remote UP such as UPF. The charging is paused in the remote UP such as UPF for this PDU session immediately.

In an embodiment, the normal pause of charging procedure is still performed and the remote UP such as UPF will have no action for pause of charging since the action of pause of charging has been performed before. The normal pause of charging procedure is still performed due to the following reasons:
The later unpause charging procedure needs to perform on the remote CP. The CP may inform the remote CP to stop pause of charging if need unpause;
If the sending of the new GTP-U message is failed, the existing mechanism can still work to keep the pause of charging work properly.

In an embodiment, the proposed solution for the over-charging problem may be applied in at least one of scenarios:
4G CUPS with SGW-C and PGW-C,
5G Roaming with V-SMF and H-SMF,
5G with I-SMF and I-UPF inserted
5G with I-UPF inserted and without I-SMF inserted

In an embodiment, an intermediate UP such as UPF is able to forward the information regarding the charging action for the first session to a next downstream UP entity when it receives the same information regarding the charging action for the first session from an upstream UP entity, e.g. UE-NG-RAN-I-UPF-I-UPF2 (e.g. BP(Branching Point))-PSA 1, where I-UPF2 shall forward the information regarding the charging action for the first session received from I-UPF to the PSA 1.

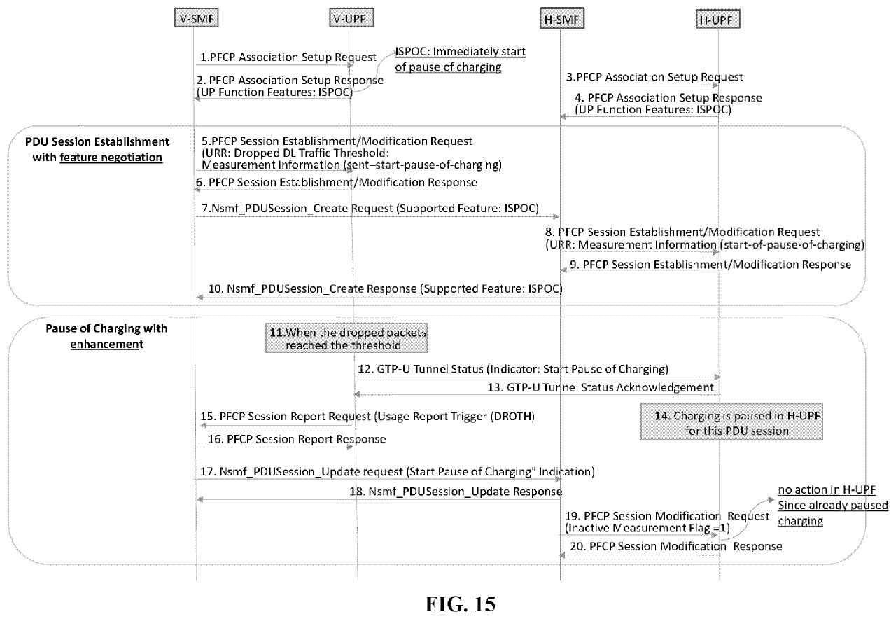

FIG. 15 shows a flowchart of solution for solving overcharging problem in a scenario of 5G roaming according to an embodiment of the present disclosure.

At step 1, V-SMF sends PFCP Association Setup Request to V-UPF.

At step 2, V-UPF sends PFCP Association Setup Response with UP Function Features: ISPOC (immediately start of pause of charging) to V-SMF to inform that V-UPF supporting ISPOC.

At step 3, H-SMF sends PFCP Association Setup Request to H-UPF.

At step 4, H-UPF sends PFCP Association Setup Response with UP Function Features: ISPOC (immediately start of pause of charging) to H-SMF to inform that H-UPF supporting ISPOC.

During the PDU session establishment procedure, at step 5, the V-SMF sends PFCP Session Establishment/Modification Request with Measurement Information: sent-start-pause-of-charging to the V-UPF. This indicator is used to tell UPF to send a new GTP-U message with an indicator (Start Pause of Charging) upon DL threshold is reached.

At step 6, the V-UPF sends PFCP Session Establishment/Modification Response to the V-SMF.

At step 7, the V-SMF sends Nsmf_PDUSession_Create Request (Supported Feature: ISPOC) to H-SMF.

At step 8, the H-SMF sends PFCP Session Establishment/Modification Request with Measurement Information: start-pause-of-charging to the H-UPF. This indicator is used to tell

UPF to stop measurement when receiving the new GTP-U message with indicator: start of pause of charging.

At step 9, the H-UPF sends PFCP Session Establishment/Modification Response to the H-SMF.

At step 10, the H-SMF sends Nsmf_PDUSession_Create Response (Supported Feature: ISPOC) to V-SMF.

At step 11, when later the UE enters an IDLE status, the V-UPF receives the DL data for the UE and triggers the DDN procedure, and the V-UPF starts to drop the packets for example due to slow paging response, and the dropped packets reached the threshold.

At step 12, the V-UPF immediately sends GTP-U Tunnel Status with indicator: start of pause of charging to the H-UPF.

At step 13, the H-UPF sends GTP-U Tunnel Status Acknowledgement to the V-UPF.

At step 14, the charging is paused in H-UPF for this PDU Session.

At step 15, the V-UPF sends PFCP Session Report Request (Usage Report Trigger (DROTH) to V-SMF.

At step 16, the V-SMF sends PFCP Session Report Response to V-UPF.

At step 17, the V-SMF sends Nsmf_PDUSession_Update request (Start Pause of Charging” Indication) to H-SMF.

At step 18, the H-SMF sends Nsmf_PDUSession_Update Response to V-SMF.

At step 19, the H-SMF sends PFCP Session Modification Request (Inactive Measurement Flag=1) to H-UPF.

At step 20, H-UPF sends PFCP Session Modification Response to H-SMF.

Steps 15-20 are the normal Pause of Charging procedure and H-UPF will have no action for pause of charging since the action of pause of charging is already performed at step 14 of FIG. 15.

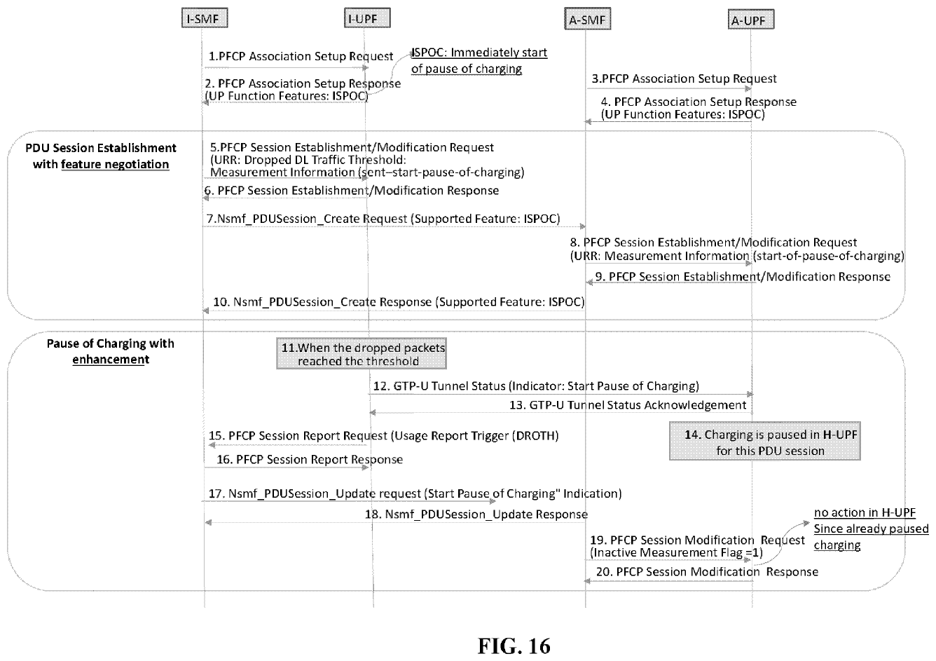

FIG. 16 shows a flowchart of solution for solving overcharging problem in a scenario of I-SMF and I-UPF inserted in 5G according to an embodiment of the present disclosure.

At step 1, I-SMF sends PFCP Association Setup Request to I-UPF.

At step 2, I-UPF sends PFCP Association Setup Response with UP Function Features: ISPOC (immediately start of pause of charging) to I-SMF to inform that I-UPF supporting ISPOC.

At step 3, A-SMF sends PFCP Association Setup Request to A-UPF.

At step 4, A-UPF sends PFCP Association Setup Response with UP Function Features: ISPOC (immediately start of pause of charging) to A-SMF to inform that A-UPF supporting ISPOC.

During the PDU session establishment procedure, at step 5, the I-SMF sends PFCP Session Establishment/Modification Request with Measurement Information: sent-start-pause-of-charging to the I-UPF. This indicator is used to tell UPF to send a new GTP-U message with an indicator (Start Pause of Charging) upon DL threshold is reached.

At step 6, the I-UPF sends PFCP Session Establishment/Modification Response to the V-SMF.

At step 7, the I-SMF sends Nsmf_PDUSession_Create Request (Supported Feature: ISPOC) to A-SMF.

At step 8, the A-SMF sends PFCP Session Establishment/Modification Request with Measurement Information: start-pause-of-charging to the A-UPF. This indicator is used to tell UPF to stop measurement when receiving the new GTP-U message with indicator: start of pause of charging.

At step 9, the A-UPF sends PFCP Session Establishment/Modification Response to the A-SMF.

At step 10, the A-SMF sends Nsmf_PDUSession_Create Response (Supported Feature: ISPOC) to V-SMF.

At step 11, when later the UE enters an IDLE status, the I-UPF receives the DL data for the UE and triggers the DDN procedure, and the I-UPF starts to drop the packets for example due to slow paging response, and the dropped packets reached the threshold.

At step 12, the I-UPF immediately sends GTP-U Tunnel Status with indicator: start of pause of charging to the A-UPF.

At step 13, the A-UPF sends GTP-U Tunnel Status Acknowledgement to the I-UPF.

At step 14, the charging is paused in A-UPF for this PDU Session.

At step 15, the I-UPF sends PFCP Session Report Request (Usage Report Trigger (DROTH) to I-SMF.

At step 16, the I-SMF sends PFCP Session Report Response to I-UPF.

At step 17, the I-SMF sends Nsmf_PDUSession_Update request (Start Pause of Charging” Indication) to A-SMF.

At step 18, the A-SMF sends Nsmf_PDUSession_Update Response to I-SMF.

At step 19, the A-SMF sends PFCP Session Modification Request (Inactive Measurement Flag=1) to A-UPF.

At step 20, A-UPF sends PFCP Session Modification Response to A-SMF.

Steps 15-20 are the normal Pause of Charging procedure and A-UPF will have no action for pause of charging since the action of pause of charging is already performed at step 14 of FIG. 16.

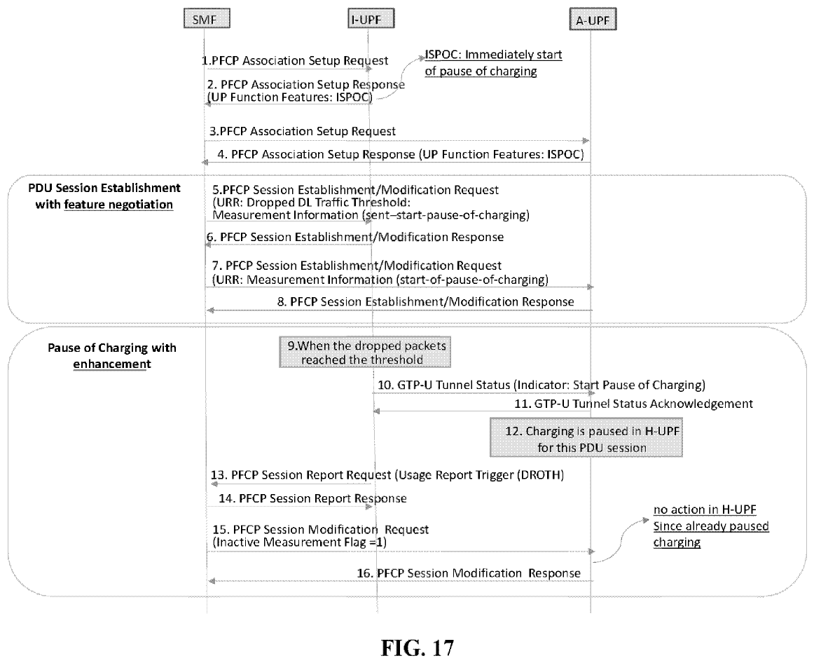

FIG. 17 shows a flowchart of solution for solving overcharging problem in a scenario of I-UPF inserted and without I-SMF inserted in 5G according to an embodiment of the present disclosure.

At step 1, SMF sends PFCP Association Setup Request to I-UPF.

At step 2, I-UPF sends PFCP Association Setup Response with UP Function Features: ISPOC (immediately start of pause of charging) to SMF to inform that I-UPF supporting ISPOC.

At step 3, SMF sends PFCP Association Setup Request to A-UPF.

At step 4, A-UPF sends PFCP Association Setup Response with UP Function Features: ISPOC (immediately start of pause of charging) to SMF to inform that H-UPF supporting ISPOC to SMF. During the PDU session establishment procedure, at step 5, the SMF sends PFCP

Session Establishment/Modification Request with Measurement Information: sent-start-pause-of-charging to the I-UPF. This indicator is used to tell UPF to send a new GTP-U message with an indicator (Start Pause of Charging) upon DL threshold is reached.

At step 6, the I-UPF sends PFCP Session Establishment/Modification Response to the SMF.

At step 7, the SMF sends PFCP Session Establishment/Modification Request with Measurement Information: start-pause-of-charging to the A-UPF. This indicator is used to tell UPF to stop measurement when receiving the new GTP-U message with indicator: start of pause of charging.

At step 8, the A-UPF sends PFCP Session Establishment/Modification Response to the SMF.

At step 9, when later the UE enters an IDLE status, the I-UPF receives the DL data for the UE and triggers the DDN procedure, and the I-UPF starts to drop the packets for example due to slow paging response, and the dropped packets reached the threshold.

At step 10, the I-UPF immediately sends GTP-U Tunnel Status with indicator: start of pause of charging to the A-UPF.

At step 11, the A-UPF sends GTP-U Tunnel Status Acknowledgement to the I-UPF.

At step 12, the charging is paused in A-UPF for this PDU Session.

At step 13, the I-UPF sends PFCP Session Report Request (Usage Report Trigger (DROTH) to SMF.

At step 14, the SMF sends PFCP Session Report Response to I-UPF.

At step 15, the SMF sends PFCP Session Modification Request (Inactive Measurement Flag=1) to A-UPF.

At step 16, A-UPF sends PFCP Session Modification Response to SMF.

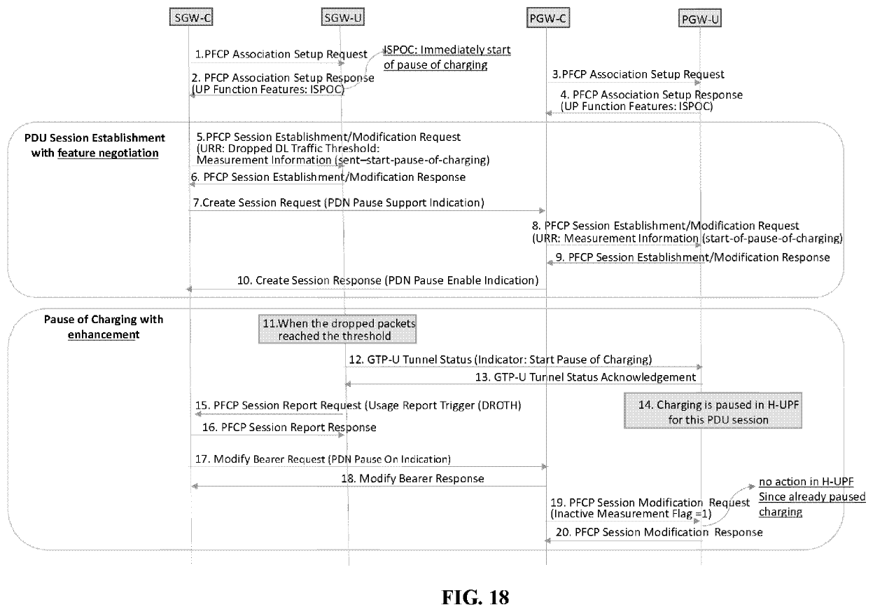

FIG. 18 shows a flowchart of solution for solving overcharging problem in a scenario of 4G CUPS according to an embodiment of the present disclosure.

At step 1, SGW-C sends PFCP Association Setup Request to SGW-U.

At step 2, SGW-U sends PFCP Association Setup Response with UP Function Features: ISPOC (immediately start of pause of charging) to SGW-C to inform that SGW-U supporting ISPOC.

At step 3, PGW-C sends PFCP Association Setup Request to PGW-U.

At step 4, PGW-U sends PFCP Association Setup Response with UP Function Features: ISPOC (immediately start of pause of charging) to PGW-C to inform that PGW-U supporting ISPOC.

During the PDU session establishment procedure, at step 5, the SGW-C sends PFCP Session Establishment/Modification Request with Measurement Information: sent-start-pause-of-charging to the SGW-U. This indicator is used to tell SGW-U to send a new GTP-U message with an indicator (Start Pause of Charging) upon DL threshold is reached.

At step 6, the SGW-U sends PFCP Session Establishment/Modification Response to the SGW-C.

At step 7, the SGW-C sends Create Session Request (PDN Pause Support Indication) to the PGW-C.

At step 8, the PGW-C sends PFCP Session Establishment/Modification Request with Measurement Information: start-pause-of-charging to the PGW-U. This indicator is used to tell PGW-U to stop measurement when receiving the new GTP-U message with indicator: start of pause of charging.

At step 9, the PGW-U sends PFCP Session Establishment/Modification Response to the PGW-C.

At step 10, the PGW-C sends Create Session Response (PDN Pause Enable Indication) to SGW-C.

At step 11, when later the UE enters an IDLE status, the SGW-U receives the DL data for the UE and triggers the DDN procedure, and the SGW-U starts to drop the packets for example due to slow paging response, and the dropped packets reached the threshold.

At step 12, the SGW-U immediately sends GTP-U Tunnel Status with indicator: start of pause of charging to the PGW-U.

At step 13, the PGW-U sends GTP-U Tunnel Status Acknowledgement to the SGW-U.

At step 14, the charging is paused in PGW-U for this PDU Session.

At step 15, the SGW-U sends PFCP Session Report Request (Usage Report Trigger (DROTH) to SGW-C.

At step 16, the SGW-C sends PFCP Session Report Response to SGW-U.

At step 17, the SGW-C sends Modify Bearer Request (PDN Pause On Indication) to PGW-C.

At step 18, the PGW-C sends Modify Bearer Response to SGW-C.

At step 19, the PGW-C sends PFCP Session Modification Request (Inactive Measurement Flag=1) to PGW-U.

At step 20, PGW-U sends PFCP Session Modification Response to PGW-C.

Steps 15-20 are the normal Pause of Charging procedure and PGW-U will have no action for pause of charging since the action of pause of charging is already performed at step 14 of FIG. 18.

In an embodiment, the following content may be added in 3GPP TS29.281 V16.1.0. A new generic Tunnel Management message, called “Tunnel Status” is introduced and can be used to notify the PGW-U or PSA UPF that the pause of charging is triggered

### 4.4.2.x Tunnel Status

The UDP destination port for the Tunnel Status shall be the user plane UDP port (2152).

### 4.4.3.x Tunnel Status

The IP Source Address shall be an IP address of the source GTP-U entity from which the message is originating.
The IP Destination Address shall be an IP address of the destination GTP-U entity.
The IP Destination Address and IP Source Address shall be the same as the corresponding GTP-U tunnel (to send G-PDU) for which the Tunnel Staus message is sent.

### 5.1 GENERAL FORMAT

The GTP-U header is a variable length header whose minimum length is 8 bytes. There are three flags that are used to signal the presence of additional optional fields: the PN flag, the S flag and the E flag. The PN flag is used to signal the presence of N-PDU Numbers. The S flag is used to signal the presence of the GTP Sequence Number field. The E flag is used to signal the presence of the Extension Header field, used to enable future extensions of the GTP header defined in this document, without the need to use another version number. If and only if one or more of these three flags are set, the fields Sequence Number, N-PDU and Extension Header shall be present. The sender shall set all the bits of the unused fields to zero. The receiver shall not evaluate the unused fields. For example, if only the E flag is set to 1, then the N-PDU Number and Sequence Number fields shall also be present, but will not have meaningful values and shall not be evaluated.
Always present fields:
Version field: This field is used to deter line the version of the GTP-U protocol. The version number shall be set to ‘1’.
Protocol Type (PT): This bit is used as a protocol discriminator between GTP (when PT is ‘1’) and GTP' (when PT is ‘0’). GTP is described in this document and the GTP' protocol in 3GPP TS 32.295 [8]. Note that the interpretation of the header fields may be different in GTP' than in GTP.
Extension Header flag (E): This flag indicates the presence of a meaningful value of the Next Extension Header field. When it is set to ‘0’, the Next Extension Header field either is not present or, if present, shall not be interpreted. When it is set to ‘1’, the Next Extension Header field is present, and shall be interpreted, as described below in this clause.
Sequence number flag (S): This flag indicates the presence of a meaningful value of the Sequence Number field. When it is set to ‘0’, the Sequence Number field either is not present or, if present, shall not be interpreted. When it is set to ‘1’, the Sequence Number field is present, and shall be interpreted, as described below in this clause.
   For the Echo Request, Echo Response, Error Indication and Supported Extension Headers Notification messages, the S flag shall be set to ‘1’. Since the use of Sequence Numbers is optional for G-PDUs, the PGW, SGW, ePDG, eNodeB and TWAN should set the flag to ‘0’. However, when a G-PDU (T-PDU+header) is being relayed by the Indirect Data Forwarding for Inter RAT HO procedure, then if the received G-PDU has the S flag set to ‘1’, then the relaying entity shall set S flag to ‘1’ and forward the G-PDU (T-PDU+header). In an End marker and Tunnel Status messages the S flag shall be set to ‘0’.
N-PDU Number flag (PN): This flag indicates the presence of a meaningful value of the N-PDU Number field. When it is set to ‘0’, the N-PDU Number field either is not present, or, if present, shall not be interpreted. When it is set to ‘1’, the N-PDU Number field is present, and shall be interpreted, as described below in this clause.
Message Type: This field indicates the type of GTP-U message.
Length: This field indicates the length in octets of the payload, i.e. the rest of the packet following the mandatory part of the GTP header (that is the first 8 octets). The Sequence Number, the N-PDU Number or any Extension headers shall be considered to be part of the payload, i.e. included in the length count.
Tunnel Endpoint Identifier (TEID): This field unambiguously identifies a tunnel endpoint in the receiving GTP-U protocol entity. The receiving end side of a GTP tunnel locally assigns the TEID value the transmitting side has to use. The TEID value shall be assigned in a non-predictable manner for PGW S5/S8/S2a/S2b interfaces (see 3GPP TS 33.250 [32]). The TEID shall be used by the receiving entity to find the PDP context, except for the following cases:
The Echo Request/Response and Supported Extension Headers notification messages, where the Tunnel Endpoint Identifier shall be set to all zeroes.
The Error Indication message where the Tunnel Endpoint Identifier shall be set to all zeros.
   When setting up a GTP-U tunnel, the GTP-U entity shall not assign the value ‘all zeros’ to its own TEID. However, for backward compatibility, if a GTP-U entity receives (via respective control plane message) a peer's TEID that is set to the value ‘all zeros’, the GTP-U entity shall accept this value as valid and send the subsequent G-PDU with the TEID field in the header set to the value ‘all zeros’.
      Optional fields:
Sequence Number: If Sequence Number field is used for G-PDUs (T-PDUs+headers), an increasing sequence number for T-PDUs is transmitted via GTP-U tunnels, when transmission order must be preserved. For Supported Extension Headers Notification and Error Indication messages, the Sequence Number shall be ignored by the receiver, even though the S flag is set to ‘1’.
N-PDU Number: This field is used at the Inter SGSN Routeing Area Update procedure and some inter-system handover procedures (e.g. between 2G and 3G radio access networks). This field is used to co-ordinate the data transmission for acknowledged mode of communication between the MS and the SGSN. The exact meaning of this field depends upon the scenario. (For example, for GSM/GPRS to GSM/GPRS, the SNDCP N-PDU number is present in this field).
Next Extension Header Type: This field defines the type of Extension Header that follows this field in the GTP-PDU.

Bits

| | | | | | | | | |
|---|---|---|---|---|---|---|---|---|
| Octets | 8 | 7 | 6 | 5 | 4 | 3 | 2 | 1 |

| | | | | | | |
|---|---|---|---|---|---|---|
| 1 | Version | PT | (*) | E | S | PN |

| | |
|---|---|
| 2 | Message Type |
| 3 | Length (1^{st} Octet) |
| 4 | Length (2^{nd} Octet) |
| 5 | Tunnel Endpoint Identifier (1^{st} Octet) |
| 6 | Tunnel Endpoint Identifier (2^{nd} Octet) |
| 7 | Tunnel Endpoint Identifier (3^{rd} Octet) |
| 8 | Tunnel Endpoint Identifier (4^{th} Octet) |
| 9 | Sequence Number (1^{st} Octet) ^{1) 4)} |
| 10 | Sequence Number (2^{nd} Octet) ^{1) 4)} |
| 11 | N-PDU Number^{2) 4)} |
| 12 | Next Extension Header Type ^{3) 4)} |

NOTE 0:
(*) This bit is a spare bit. It shall be sent as ‘0’. The receiver shall not evaluate this bit.
NOTE 1:
¹⁾ This field shall only be evaluated when indicated by the S flag set to 1.
NOTE 2:
²⁾This field shall only be evaluated when indicated by the PN flag set to 1.
NOTE 3:
³⁾ This field shall only be evaluated when indicated by the E flag set to 1.
NOTE 4:
⁴⁾ This field shall be present if and only if any one or more of the S, PN and E flags are set.

### 6.1 GENERAL

GTP-U defines a set of messages between the two ends of the user plane of the interfaces Iu, Gn, Gp, Sl-U, S11-U, S2a, S2b, S4, S5, S8, S12, X2, M1, Sn, Xn, N3, N9 and N19. GTP-U messages are sent across a GTP user plane tunnel. A GTP-U message may be either a signalling message across the user plane tunnel, or a G-PDU message.
GTP-U signalling messages are used for user plane path management, or for user plane tunnel management.
G-PDU is a vanilla user plane message, which carries the original packet (T-PDU). In G-PDU message, GTP-U header is followed by a T-PDU.
   A T-PDU is an original packet, for example an IP datagram, Ethernet frame or unstructured PDU Data, from an UE, or from a network node in an external packet data network.
   The complete range of message types defined for GTPv1 is defined in 3GPP TS 29.060 [6]. The table below includes those applicable to GTP user plane. The three columns to the right define which of the three protocols sharing the common header of GTPv1 (GTP-C, GTP-U or GTP') might implement the specific message type.

TABLE 6.1-1
Messages in GTP-U

| | | | | | |
|---|---|---|---|---|---|
| Message Type | | | | | |
| value (Decimal) | Message | Reference | GTP-C | GTP-U | GTP′ |

| | | | | |
|---|---|---|---|---|
| 1 | Echo Request | X | X | x |
| 2 | Echo Response | X | X | x |
| 3-25 | Reserved in 3GPP TS 32.295 [8] and 3GPP TS | | | |
| | 29.060 [6] | | | |
| 26 | Error Indication | | X | |
| 27-30 | Reserved in 3GPP TS 29.060 [6] | | | |
| 31 | Supported Extension Headers Notification | X | X | |
| 32-25y | Reserved in 3GPP TS 29.060 [6] | | | |
| 25x | Tunnel Status | | X | |
| 254 | End Marker | | X | |
| 255 | G-PDU | | X | |

### 7.3.2 End Marker

### 7.3.2.1 General

The End Marker message indicates the end of the payload stream on a given tunnel, i.e. a G-PDU that arrives after an End Marker message on this tunnel may be silently discarded. Table 7.3.2.1-1 specifies the information element included in the End Marker message.
If an End Marker message is received with a TEID for which there is no context, then the receiver shall ignore this message.
The optional Private Extension contains vendor or operator specific information.

TABLE 7.3.2.1-1
Information Elements in End Marker message

| Information element | Presence requirement | Reference |
|---|---|---|
| Private Extension | Optional | 8.6 |

### 7.3.x Tunnel Status

The Tunnel Status message is optional. A GTP-U entity, if it supports the message, may send one or more Tunnel Status message to the peer GTP-U entity to provide the status information related to the corresponding GTP-U tunnel in the sending GTP-U entity. Table 7.3.2.1-1 specifies the information element included in the Tunnel Status message.
If a Tunnel Status message is received with a TEID for which there is no context, or the message is not supported, then the receiver shall ignore this message.
The optional Private Extension contains vendor or operator specific information.

TABLE 7.3.x-1
Information Elements in Tunnel Status message

| Information element | Presence requirement | Reference |
|---|---|---|
| GTP-U Tunnel Status Information | Mandatory | 8.x |
| Private Extension | Optional | 8.6 |

### 8.1 INFORMATION ELEMENT TYPES

A GTP-U Signalling message may contain several information elements. The TLV (Type, Length, Value) or TV (Type, Value) encoding format shall be used for the GTP information elements. The information elements shall be sorted, with the Type fields in ascending order, in the signalling messages. The Length field contains the length of the information element excluding the Type and Length field.
For all the length fields, bit 8 of the lowest numbered octet is the most significant bit and bit 1 of the highest numbered octet is the least significant bit.
Within information elements, certain fields may be described as spare. These bits shall be transmitted with the value defined for them. To allow for future features, the receiver shall not evaluate these bits.
The most significant bit in the Type field is set to 0 when the TV format is used and set to 1 for the TLV format.

Type field for TV and TLV format

| | Bits | | | | | | | |
|---|---|---|---|---|---|---|---|---|
| Octets | 8 | 7 | 6 | 5 | 4 | 3 | 2 | 1 |

| | | |
|---|---|---|
| 1 | 0 | Type −> TV format |
| | 1 | Type −> TLV format |

The complete range of information element types defined for GTPv1 is defined in 3GPP TS 29.060 [6]. The table below includes those applicable to GTP user plane.

TABLE 8.1-1
Information Elements

| IE Type | | | |
|---|---|---|---|
| Value | Format | Information Element | Reference |
| 0-13 | TV | Reserved in 3GPP TS 29.060 [6] | |
| 14 | TV | Recovery | 8.2 |
| 15 | TV | Reserved in 3GPP TS 29.060 [6] | |
| 16 | TV | Tunnel Endpoint Identifier Data I | 8.3 |
| 17-132 | TV/TLV | Reserved in 3GPP TS 29.060 [6] | |
| 133 | TLV | GSN Address. See NOTE 1. | 8.4 |
| 134-140 | TLV | Reserved in 3GPP TS 29.060 [6] | |
| 141 | TLV | Extension Header Type List | 8.5 |
| 142-229 | TLV | Reserved in 3GPP TS 29.060 [6] | |
| 230 | TLV | GTP-U Tunnel Status Information | 8.X |
| 231-237 | TLV | Spare. For future use. | |
| 238-254 | TLV | Reserved in 3GPP TS 29.060 [6] | |
| 255 | TLV | Private Extension | 8.6 |

NOTE 1:
This IE is named as “GTP-U Peer Address” in the rest of this specification.
***Next Change****

### 8.X GTP-U TUNNEL STATUS INFORMATION

The GTP-U Tunnel Status Information contains the status information related to the corresponding GTP-U tunnel in the sending GTP-U entity.

GTP-U Tunnel Status Information

| | Bits | | | | | | | |
|---|---|---|---|---|---|---|---|---|
| Octets | 8 | 7 | 6 | 5 | 4 | 3 | 2 | 1 |

| 1 to 2 | Type = 230 (decimal) | |
|---|---|---|
| 3 to 4 | Length = n | |
| 5 | Spare | SPOC |

| | |
|---|---|
| 6 to (n + 4) | These octet(s) is/are present only if explicitly specified |

The octet 5 shall be encoded as follows:
Bit 1—SPOC (Start Pause Of Charging): when set to “1”, this indicates a request to the receiving GTP-U entity to stop usage measurement for the URR(s) with the indication applicable for charging for given PFCP session. The GTP-U entity shall forward Tunnel Status message to the upstream GTP-U entity if it is not a PSA UPF or PGW-U connecting to N6/SGi interface.
Bit 2 to 8—Spare, for future use and set to “0”.

In an embodiment, the following content may be added in 3GPP TS29.244 V16.6.0.

### 5.2.2.2.1 General

When the NSPOC feature as specified in clause 5.x is supported by the CP and UP function, the CP function may provision:
a Measurement Infounation with the ‘Send Start Pause of Charging’ Flag set to “1”, to request the UP function (SGW-U or I/V-UPF) to send a Start Pause of Charging indication to the upstream GTP-U entity(s) when the Dropped DL Traffic Threshold is reached.
a Measurement Infounation with the ‘Applicable for Start of Pause of Charging’ Flag set to “1”, to indicate the UP function to stop the usage measurement for the URR when receiving Start Pause of Charging indication from the peer GTP-U entity.
   The CP function may request the UP function to measure network resources usage and generate the corresponding Usage Reports only for a number of times, by provisioning the “Number of Reports” IE in a URR, if the UP function supports the NORP feature (see clause 8.2.25-1). If so, the URR shall become inactive in the UP function after the requested “Number of Reports” have been reported.
   The CP function may resume the measurement for an inactive URR by setting the Inactive Measurement flag of the Measurement Information IE of the URR to “0” in the Update URR IE in a PFCP Session Modification Request message, with or without the Number of Report IE. If the CP function wishes the UP function to perform continuous measurement for a URR which was provisioned with a Number of Reports (i.e. to no longer limit the number of reports to be generated), the CP function shall provide the Number of Reports IE in the Update URR with a null length to delete the limit on the number of reports to be generated. NOTE 12: The Number of Reports can be provisioned in a URR regardless which Measurement Method is used.

### 5.x NOTIFYING START PAUSE OF CHARGING

The requirements for PGW Pause of Charging in EPC are specified in 3GPP TS 23.401 [14 ] and the requirements for SMF Pause of Charging feature for 5GC are specified in 3GPP TS 23.502 [29].
To reduce the charging discrepancy between SGW-C and PGW-C, or between I/V-SMF and (h)SMF due to the signalling latency to notify start pause of charging, the CP function (SGW-C and PGW-C for EPC, UV-SMF and (h)SMF for 5GC) and UP function (SGW-U and PGW-U for EPC, UV-UPF and PSA UPF) may support the Notify Start Pause of Charging via user plane feature (NSPOC) as described below.
When both the CP function and the UP function support the NSPOC feature, the CP function (SGW-C, or UV-SMF) may set the SSPOC bit to “1” in the Measurement Information included in the URR when the Dropped DL Traffic Threshold is provisioned, to request the UP function (SGW-C, UV-UPF) to send a Start Pause of Charging indication via one or more GTP-U Tunnel Status message to the upstream GTP-U entity(s) when the Dropped DL Traffic Threshold is reached.
When both the CP function and the UP function support the NSPOC feature, the CP function (PGW-C, or (h)SMF) may set the ASPOC bit to “1” in the Measurement Information included in the URR if the URR is intended for charging, to request the UP function to stop the usage measurement for the URR when receiving Start Pause of Charging indication from the peer downstream GTP-U entity, so that the UP function shall behave as if the Inactive Measurement flag had been set for the URR when it receives a Tunnel Status message with the Start Pause of Charging indication is set to “1” from the downstream peer GTP-U entity.
NOTE 1: The existing procedures (using control plane signalling) to Start Pause of Charging is not impacted; and the existing mechanism to stop Pause of Charging remains intact.
NOTE 2: The UP function will forward Tunnel Status message to the upstream GTP-U entity(s) if it is not a PSA UPF or PGW-U connecting to N6 or SGi interface. If the UP function is a UL/CL or BP, it needs send or forward the Tunnel Status message to all of PSA UPFs.
NOTE 3: When the CP function knows that there are at least some of PGW-Us or PSA UPFs supporting the NSPOC feature, then the CP function can request the UP function to use the feature, i.e. sending GTP-U Tunnel Status message to the upstream GTP-U entity(s) when the Dropped DL Traffic Threshold is reached.

### 7.5.2.4 Create URR IE within PFCP Session Establishment Request

The Create URR grouped IE shall be encoded as shown in FIG. 7.5.2.4-1 of 3GPP TS29.244 V16.6.0.

TABLE 7.5.2.4-1
Create URR IE within PFCP Session Establishment Request

| | Create URR IE Type = 6 (decimal) | | | | | | |
|---|---|---|---|---|---|---|---|
| Octet 1 and 2 | Length = n | | | | | | |
| Octets 3 and 4 | | | Appl. | | | | |
| Information | | | Sx | Sx | Sx | | |
| elements | P | Condition/Comment | a | b | c | N4 | IE Type |
| URR ID | M | This IE shall uniquely identify the URR among all the | X | X | X | X | URR ID |
| | | URRs configured for this PFCP session. | | | | | |
| Measurement | M | This IE shall indicate the method for measuring the | X | X | X | X | Measurement |
| Method | | network resources usage, i.e. whether the data volume, | | | | | Method |
| | | duration (i.e. time), combined volume/duration, or event | | | | | |
| | | shall be measured. | | | | | |
| Reporting Triggers | M | This IE shall indicate the trigger(s) for reporting network | X | X | X | X | Reporting |
| | | resources usage to the CP function, e.g. periodic reporting | | | | | Triggers |
| | | or reporting upon reaching a threshold, or envelope | | | | | |
| | | closure, or when an SMF instructs an UPF to report the | | | | | |
| | | reception of the End Marker packet from the old I-UPF | | | | | |
| | | during a Service Request procedure (see clauses 4.2.3.2 | | | | | |
| | | and 4.23.4.3 in 3GPP TS 23.502 [29]). | | | | | |
| Measurement | C | This IE shall be present if periodic reporting is required. | X | X | X | X | Measurement |
| Period | | When present, it shall indicate the period for generating | | | | | Period |
| | | and reporting usage reports. | | | | | |
| Volume Threshold | C | This IE shall be present if volume-based measurement is | X | X | X | X | Volume |
| | | used and reporting is required upon reaching a volume | | | | | Threshold |
| | | threshold. When present, it shall indicate the traffic volume | | | | | |
| | | value after which the UP function shall report network | | | | | |
| | | resources usage to the CP function for this URR. | | | | | |
| Volume Quota | C | This IE shall be present if volume-based measurement is | — | X | X | X | Volume Quota |
| | | used and the CP function needs to provision a Volume | | | | | |
| | | Quota in the UP function (see clause 5.2.2.2) | | | | | |
| | | When present, it shall indicate the Volume Quota value. | | | | | |
| Event Threshold | C | This IE shall be present if event-based measurement is | — | X | X | X | Event Threshold |
| | | used and reporting is required upon reaching an event | | | | | |
| | | threshold. When present, it shall indicate the number of | | | | | |
| | | events after which the UP function shall report to the CP | | | | | |
| | | function for this URR. | | | | | |
| Event Quota | C | This IE shall be present if event-based measurement is | — | X | X | X | Event Quota |
| | | used and the CP function needs to provision an Event | | | | | |
| | | Quota in the UP function (see clause 5.2.2.2) | | | | | |
| | | When present, it shall indicate the Event Quota value. | | | | | |
| Time Threshold | C | This IE shall be present if time-based measurement is | X | X | X | X | Time Threshold |
| | | used and reporting is required upon reaching a time | | | | | |
| | | threshold. When present, it shall indicate the time usage | | | | | |
| | | after which the UP function shall report network resources | | | | | |
| | | usage to the CP function for this URR. | | | | | |
| Time Quota | C | This IE shall be present if time-based measurement is | — | X | X | X | Time Quota |
| | | used and the CP function needs to provision a Time Quota | | | | | |
| | | in the UP function (see clause 5.2.2.2) | | | | | |
| | | When present, it shall indicate the Time Quota value | | | | | |
| Quota Holding | C | This IE shall be present, for a time, volume or event-based | — | X | X | X | Quota Holding |
| Time | | measurement, if reporting is required and packets are no | | | | | Time |
| | | longer permitted to pass on when no packets are received | | | | | |
| | | during a given inactivity period. | | | | | |
| | | When present, it shall contain the duration of the inactivity | | | | | |
| | | period. | | | | | |
| Dropped DL | C | This IE shall be present if reporting is required when the | X | — | — | X | Dropped DL |
| Traffic Threshold | | DL traffic being dropped exceeds a threshold. | | | | | Traffic Threshold |
| | | When present, it shall contain the threshold of the DL | | | | | |
| | | traffic being dropped. | | | | | |
| Quota Validity | C | This IE shall be present if reporting is required when the | — | X | — | X | Quota Validity |
| Time | | Quota Validity time for a given Quota is over. | | | | | Time |
| Monitoring Time | O | When present, this IE shall contain the time at which the | X | X | X | X | Monitoring Time |
| | | UP function shall re-apply the volume or time threshold. | | | | | |
| Subsequent | O | This IE may be present if the Monitoring Time IE is present | X | X | X | X | Subsequent |
| Volume Threshold | | and volume-based measurement is used. | | | | | Volume |
| | | When present, it shall indicate the traffic volume value | | | | | Threshold |
| | | after which the UP function shall report network resources | | | | | |
| | | usage to the CP function for this URR for the period after | | | | | |
| | | the Monitoring Time. | | | | | |
| Subsequent Time | O | This IE may be present if the Monitoring Time IE is present | X | X | X | X | Subsequent |
| Threshold | | and time-based measurement is used. | | | | | Time Threshold |
| | | When present, it shall indicate the time usage after which | | | | | |
| | | the UP function shall report network resources usage to | | | | | |
| | | the CP function for this URR for the period after the | | | | | |
| | | Monitoring Time. | | | | | |
| Subsequent | O | This IE may be present if Monitoring Time IE is present | — | X | X | X | Subsequent |
| Volume Quota | | and volume-based measurement is used (see clause | | | | | Volume Quota |
| | | 5.2.2.2). | | | | | |
| | | When present, it shall indicate the Volume Quota value | | | | | |
| | | which the UP function shall use for this URR for the period | | | | | |
| | | after the Monitoring Time. | | | | | |
| Subsequent Time | O | This IE may be present if Monitoring Time IE is present | — | X | X | X | Subsequent |
| Quota | | and time-based measurement is used (see clause 5.2.2.2) | | | | | Time Quota |
| | | When present, it shall indicate the Time Quota value which | | | | | |
| | | the UP function shall use for this URR for the period after | | | | | |
| | | the Monitoring Time. | | | | | |
| Subsequent Event | O | This IE may be present if the Monitoring Time IE is present | — | X | X | X | Subsequent |
| Threshold | | and event-based measurement is used. | | | | | Event Threshold |
| | | When present, it shall indicate the number of events after | | | | | |
| | | which the UP function shall report to the CP function for | | | | | |
| | | this URR for the period after the Monitoring Time. | | | | | |
| Subsequent Event | O | This IE may be present if Monitoring Time IE is present | — | X | X | X | Subsequent |
| Quota | | and event-based measurement is used (see clause | | | | | Event Quota |
| | | 5.2.2.2). | | | | | |
| | | When present, it shall indicate the Event Quota value | | | | | |
| | | which the UP function shall use for this URR for the period | | | | | |
| | | after the Monitoring Time. | | | | | |
| Inactivity | C | This IE shall be present if time-based measurement is | — | X | X | X | Inactivity |
| Detection Time | | used and the time measurement need to be suspended | | | | | Detection Time |
| | | when no packets are received during a given inactivity | | | | | |
| | | period. When present, it shall contain the duration of the | | | | | |
| | | inactivity period. | | | | | |
| Linked URR ID | C | This IE shall be present if linked usage reporting is | — | X | X | X | Linked URR ID |
| | | required. When present, this IE shall contain the linked | | | | | |
| | | URR ID which is related with this URR (see clause | | | | | |
| | | 5.2.2.4). | | | | | |
| | | Several IEs with the same IE type may be present to | | | | | |
| | | represent multiple linked URRs which are related with this | | | | | |
| | | URR. | | | | | |
| Measurement | C | This IE shall be included if any of the following flag is set to “1”. | | | | | Measurement |
| Information | | Applicable flags are: | | | | | Information |
| | | Measurement Before QoS Enforcement | — | X | X | X | |
| | | Flag: this flag shall be set to “1” if the traffic usage | | | | | |
| | | before any QoS Enforcement is requested to be | | | | | |
| | | measured. | | | | | |
| | | Inactive Measurement Flag: this flag shall | — | X | — | X | |
| | | be set to “1” if the measurement shall be paused | | | | | |
| | | (inactive). The measurement shall be performed | | | | | |
| | | (active) if the bit is set to “0” or if the Measurement | | | | | |
| | | Information IE is not present in the Create URR IE. | | | | | |
| | | Reduced Application Detection | — | X | — | X | |
| | | Information Flag: this flag may be set to “1”, if the | | | | | |
| | | Reporting Triggers request to report the start or | | | | | |
| | | stop of application, to request the UP function to | | | | | |
| | | only report the Application ID in the Application | | | | | |
| | | Detection Information, e.g. for envelope reporting. | | | | | |
| | | Immediate Start Time Metering Flag: this | — | X | X | X | |
| | | flag may be set to “1” if time-based measurement | | | | | |
| | | is used and the UP function is requested to start | | | | | |
| | | the time metering immediately at receiving the | | | | | |
| | | flag . . . | | | | | |
| | | Measurement of Number of Packets Flag: | X | X | X | X | |
| | | this flag may be set to “1” when the Volume-based | | | | | |
| | | measurement applies, to request the UP function | | | | | |
| | | to report the number of packets in UL/DL/Total in | | | | | |
| | | addition to the measurement in octet. | | | | | |
| | | Send Start Pause of Charging Flag: this | X | — | — | X | |
| | | flag may be set to “1” by the CP function if the UP | | | | | |
| | | Function is requested to send a Start Pause of | | | | | |
| | | Charging indication to the upstream GTP-U | | | | | |
| | | entity(s) when the Dropped DL Traffic Threshold is | | | | | |
| | | reached. | | | | | |
| | | Applicable for Start of Pause of Charging | — | X | — | X | |
| | | Flag: this flag may be set to “1” if the URR is | | | | | |
| | | applicable for Start of Pause of Charging, so that | | | | | |
| | | the UP function shall stop the usage measurement | | | | | |
| | | for the URR when receiving Start Pause of | | | | | |
| | | Charging indication from the peer downstream | | | | | |
| | | GTP-U entity. | | | | | |
| Time Quota | C | This IE shall be present if time-based measurement based | — | X | — | — | Time Quota |
| Mechanism | | on CTP or DTP is used. | | | | | Mechanism |
| Aggregated URRs | C | This IE shall be included if the URR is used to support a | — | X | — | — | Aggregated |
| | | Credit Pool. | | | | | URRs |
| | | Several IEs with the same IE type may be present to | | | | | |
| | | provide multiple aggregated URRs. | | | | | |
| FAR ID for Quota | C | This IE may be present if the Volume Quota IE and/or the | — | X | X | X | FAR ID |
| Action | | Time Quota IE and/or Event Quota IE is provisioned in the | | | | | |
| | | URR and the UP Function indicated support of the Quota | | | | | |
| | | Action feature. | | | | | |
| | | When present, it shall contain the identifier of the | | | | | |
| | | substitute FAR the UP function shall apply, for the traffic | | | | | |
| | | associated to this URR, when exhausting any of these | | | | | |
| | | quotas. See NOTE 1. | | | | | |
| Ethernet Inactivity | C | This IE shall be present if Ethernet traffic reporting is used | — | — | — | X | Ethernet |
| Timer | | and the SMF requests the UP function to also report | | | | | Inactivity Timer |
| | | inactive UE MAC addresses. | | | | | |
| | | When present, it shall contain the duration of the Ethernet | | | | | |
| | | inactivity period. | | | | | |
| Additional | O | When present, this IE shall contain the time at which the | X | X | X | X | Additional |
| Monitoring Time | | UP function shall re-apply the volume or time or event | | | | | Monitoring Time |
| | | threshold/quota provisioned in the IE. | | | | | |
| | | Several IEs with the same IE type may be present to | | | | | |
| | | provide multiple Monitoring Times. | | | | | |
| Number of Reports | O | This IE may be present if the UP function supports the | X | X | X | X | Number of |
| | | NORP feature. When present, it shall indicate the number | | | | | Reports |
| | | of usage reports to be generated by the URR. See also | | | | | |
| | | clauses 5.2.2.2.1 and 5.2.2.3.1. See NOTE 2. | | | | | |

NOTE 1:
The substitute FAR used when exhausting a Volume Quota or Time Quota may be set to drop the packets or redirect the traffic towards a redirect destination as specified in clause 5.4.7.
NOTE 2:
This IE may be provisioned and set to “1” e.g. for a URR with the Dropped DL Traffic Threshold used for the Pause of Charging feature, if the UP function supports the NORP feature.

TABLE 7.5.2.4-2
Aggregated URRs

| | Aggregated URRs = 118 (decimal) | | | | | | |
|---|---|---|---|---|---|---|---|
| Octet 1 and 2 | Length = n | | | | | | |
| Octets 3 and 4 | | | Appl. | | | | |
| Information | | | Sx | Sx | Sx | | |
| elements | P | Condition/Comment | a | b | c | N4 | IE Type |
| Aggregated URR | M | This IE shall be present for the aggregated URR ID of the | — | X | — | — | Aggregated |
| ID | | URR sharing the credit pool. | | | | | URR ID |
| Multiplier | M | This IE shall be included to measure the abstract service | — | X | — | — | Multiplier |
| | | units the traffic of the corresponding aggregated URR | | | | | |
| | | consumes from the credit pool. | | | | | |

TABLE 7.5.2.4-3
Additional Monitoring Time

| | Additional Monitoring Time = 147 (decimal) | | | | | | |
|---|---|---|---|---|---|---|---|
| Octet 1 and 2 | Length = n | | | | | | |
| Octets 3 and 4 | | | Appl. | | | | |
| Information | | | Sx | Sx | Sx | | |
| elements | P | Condition/Comment | a | b | c | N4 | IE Type |
| Monitoring Time | M | This IE shall be present and contain the time at which the | X | X | X | X | Monitoring Time |
| | | UP function shall re-apply the volume or time | | | | | |
| | | threshold/quota. | | | | | |
| Subsequent | O | This IE may be present if the Monitoring Time IE is present | X | X | X | X | Subsequent |
| Volume Threshold | | and volume-based measurement is used. | | | | | Volume |
| | | When present, it shall indicate the traffic volume value | | | | | Threshold |
| | | after which the UP function shall report network resources | | | | | |
| | | usage to the CP function for this URR for the period after | | | | | |
| | | the Monitoring Time. | | | | | |
| Subsequent Time | O | This IE may be present if the Monitoring Time IE is present | X | X | X | X | Subsequent |
| Threshold | | and time-based measurement is used. | | | | | Time Threshold |
| | | When present, it shall indicate the time usage after which | | | | | |
| | | the UP function shall report network resources usage to | | | | | |
| | | the CP function for this URR for the period after the | | | | | |
| | | Monitoring Time. | | | | | |
| Subsequent | O | This IE may be present if Monitoring Time IE is present | — | X | X | X | Subsequent |
| Volume Quota | | and volume-based measurement is used (see clause | | | | | Volume Quota |
| | | 5.2.2.2). | | | | | |
| | | When present, it shall indicate the Volume Quota value | | | | | |
| | | which the UP function shall use for this URR for the period | | | | | |
| | | after the Monitoring Time. | | | | | |
| Subsequent Time | O | This IE may be present if Monitoring Time IE is present | — | X | X | X | Subsequent |
| Quota | | and time-based measurement is used (see clause 5.2.2.2) | | | | | Time Quota |
| | | When present, it shall indicate the Time Quota value which | | | | | |
| | | the UP function shall use for this URR for the period after | | | | | |
| | | the Monitoring Time. | | | | | |
| Subsequent Event | O | This IE may be present if the Monitoring Time IE is present | — | X | X | X | Event Threshold |
| Threshold | | and event-based measurement is used. | | | | | |
| | | When present, it shall indicate the number of events after | | | | | |
| | | which the UP function shall report to the CP function for | | | | | |
| | | this URR for the period after the Monitoring Time. | | | | | |
| Subsequent Event | O | This IE may be present if Monitoring Time IE is present | — | X | X | X | Event Quota |
| Quota | | and event-based measurement is used (see clause | | | | | |
| | | 5.2.2.2). | | | | | |
| | | When present, it shall indicate the Event Quota value | | | | | |
| | | which the UP function shall use for this URR for the period | | | | | |
| | | after the Monitoring Time. | | | | | |

### 7.5.4.4 Update URR IE within PFCP Session Modification Request

The Update URR grouped IE shall be encoded as shown in FIG. 7.5.4.4-1 of 3GPP TS29.244 V16.6.0.

TABLE 7.5.4.4-1
Update URR IE within PFCP Session Modification Request

| | Update URR IE Type = 13 (decimal) | | | | | | |
|---|---|---|---|---|---|---|---|
| Octet 1 and 2 | Length = n | | | | | | |
| Octets 3 and 4 | | | Appl. | | | | |
| Information | | | Sx | Sx | Sx | | |
| elements | P | Condition/Comment | a | b | c | N4 | IE Type |
| URR ID | M | This IE shall uniquely identify the URR among all the | X | X | X | X | URR ID |
| | | URRs configured for that PFCP session | | | | | |
| Measurement | C | This IE shall be present if the measurement method needs | X | X | X | X | Measurement |
| Method | | to be modified. | | | | | Method |
| | | When present, this IE shall indicate the method for | | | | | |
| | | measuring the network resources usage, i.e. whether the | | | | | |
| | | data volume, duration (i.e. time), combined | | | | | |
| | | volume/duration, or event shall be measured. | | | | | |
| Reporting Triggers | C | This IE shall be present if the reporting triggers needs to | X | X | X | X | Reporting |
| | | be modified. | | | | | Triggers |
| | | When present, this IE shall indicate the trigger(s) for | | | | | |
| | | reporting network resources usage to the CP function, e.g. | | | | | |
| | | periodic reporting or reporting upon reaching a threshold, | | | | | |
| | | or envelope closure, or when an SMF instructs an UPF to | | | | | |
| | | report the reception of the End Marker packet from the old | | | | | |
| | | I-UPF during a Service Request procedure (see clauses | | | | | |
| | | 4.2.3.2 and 4.23.4.3 in 3GPP TS 23.502 [29]). | | | | | |
| Measurement | C | This IE shall be present if the Measurement Period needs | X | X | X | X | Measurement |
| Period | | to be modified | | | | | Period |
| | | When present, it shall indicate the period for generating | | | | | |
| | | and reporting usage reports. | | | | | |
| Volume Threshold | C | This IE shall be present if the Volume Threshold needs to | X | X | X | X | Volume |
| | | be modified. When present, it shall indicate the traffic | | | | | Threshold |
| | | volume value after which the UP function shall report | | | | | |
| | | network resources usage to the CP function for this URR. | | | | | |
| Volume Quota | C | This IE shall be present if the Volume Quota needs to be | — | X | X | X | Volume Quota |
| | | modified. | | | | | |
| | | When present, it shall indicate the Volume Quota value. | | | | | |
| Time Threshold | C | This IE shall be present if the Time Threshold needs to be | X | X | X | X | Time Threshold |
| | | modified. When present, it shall indicate the time usage | | | | | |
| | | after which the UP function shall report network resources | | | | | |
| | | usage to the CP function for this URR. | | | | | |
| Time Quota | C | This IE shall be present if the Time Quota needs to be | — | X | X | X | Time Quota |
| | | modified. | | | | | |
| | | When present, it shall indicate the Time Quota value. | | | | | |
| Event Threshold | C | This IE shall be present if Event Threshold needs to be | — | X | X | X | Event Threshold |
| | | modified. | | | | | |
| | | When present, it shall indicate the number of events after | | | | | |
| | | which the UP function shall report to the CP function for | | | | | |
| | | this URR. | | | | | |
| Event Quota | C | This IE shall be present if Event Quota needs to be | — | X | X | X | Event Quota |
| | | modified. | | | | | |
| | | When present, it shall indicate the Event Quota value. | | | | | |
| Quota Holding | C | This IE shall be present if the Quota Holding Time needs to | — | X | X | X | Quota Holding |
| Time | | be modified. | | | | | Time |
| | | When present, it shall contain the duration of the Quota | | | | | |
| | | Holding Time. | | | | | |
| Dropped DL | C | This IE shall be present if the Dropped DL Threshold | X | — | — | X | Dropped DL |
| Traffic Threshold | | needs to be modified. | | | | | Traffic Threshold |
| | | When present, it shall contain the threshold of the DL | | | | | |
| | | traffic being dropped. | | | | | |
| Quota Validity | C | This IE shall be present if Quota Validity time was not sent | — | X | — | X | Quota Validity |
| Time | | earlier or quota validity time value needs to be modified. | | | | | Time |
| Monitoring Time | C | This IE shall be present if the Monitoring Time needs to be | X | X | X | X | Monitoring Time |
| | | modified. When present, this IE shall contain the time at | | | | | |
| | | which the UP function shall re-apply the volume or time | | | | | |
| | | threshold. | | | | | |
| Subsequent | C | This IE shall be present if the Subsequent Volume | X | X | X | X | Subsequent |
| Volume Threshold | | Threshold needs to be modified and volume-based | | | | | Volume |
| | | measurement is used. | | | | | Threshold |
| | | When present, it shall indicate the traffic volume value | | | | | |
| | | after which the UP function shall report network resources | | | | | |
| | | usage to the CP function for this URR for the period after | | | | | |
| | | the Monitoring Time. | | | | | |
| Subsequent Time | C | This IE shall be present if the Subsequent Time Threshold | X | X | X | X | Subsequent |
| Threshold | | needs to be modified. When present, it shall indicate the | | | | | Time Threshold |
| | | time usage value after which the UP function shall report | | | | | |
| | | network resources usage to the CP function for this URR | | | | | |
| | | for the period after the Monitoring Time. | | | | | |
| Subsequent | C | This IE shall be present if the Subsequent Volume Quota | — | X | X | X | Subsequent |
| Volume Quota | | needs to be modified. | | | | | Volume Quota |
| | | When present, it shall indicate the Volume Quota value | | | | | |
| | | which the UP function shall use for this URR for the period | | | | | |
| | | after the Monitoring Time. | | | | | |
| Subsequent Time | C | This IE shall be present if the Subsequent Time Quota | — | X | X | X | Subsequent |
| Quota | | needs to be modified. | | | | | Time Quota |
| | | When present, it shall indicate the Time Quota value which | | | | | |
| | | the UP function shall use for this URR for the period after | | | | | |
| | | the Monitoring Time. | | | | | |
| Subsequent Event | O | This IE shall be present if the Subsequent Event Threshold | — | X | X | X | Subsequent |
| Threshold | | needs to be modified. | | | | | Event Threshold |
| | | When present, it shall indicate the number of events after | | | | | |
| | | which the UP function shall report to the CP function for | | | | | |
| | | this URR for the period after the Monitoring Time. | | | | | |
| Subsequent Event | O | This IE shall be present if the Subsequent Event Quota | — | X | X | X | Subsequent |
| Quota | | needs to be modified. | | | | | Event Quota |
| | | When present, it shall indicate the Event Quota value | | | | | |
| | | which the UP function shall use for this URR for the period | | | | | |
| | | after the Monitoring Time. | | | | | |
| Inactivity | C | This IE shall be present if the Inactivity Detection Time | — | X | X | X | Inactivity |
| Detection Time | | needs to be modified. | | | | | Detection Time |
| | | When present, it shall indicate the duration of the inactivity | | | | | |
| | | period after which time measurement needs to be | | | | | |
| | | suspended when no packets are received during this | | | | | |
| | | inactivity period. | | | | | |
| Linked URR ID | C | This IE shall be present if linked usage reporting is | — | X | X | X | Linked URR ID |
| | | required. When present, this IE shall contain the linked | | | | | |
| | | URR ID which is related with this URR (see clause | | | | | |
| | | 5.2.2.4). | | | | | |
| | | Several IEs with the same IE type may be present to | | | | | |
| | | represent multiple linked URRs which are related with this | | | | | |
| | | URR. | | | | | |
| Measurement | C | This IE shall be included if any of the following flag is set to | | | | | Measurement |
| Information | | “1”. | | | | | Information |
| | | Applicable flags are: | | | | | |
| | | Inactive Measurement Flag: this flag shall | — | X | — | X | |
| | | be set to “1” if the measurement shall be paused | | | | | |
| | | (inactive). The measurement shall be performed | | | | | |
| | | (active) if the bit is set to “0” or if the Measurement | | | | | |
| | | Information IE is not present in the Update URR IE. | | | | | |
| | | Reduced Application Detection | — | X | — | X | |
| | | Information Flag: this flag may be set to “1”, if the | | | | | |
| | | Reporting Triggers request to report the start or | | | | | |
| | | stop of application, to request the UP function to | | | | | |
| | | only report the Application ID in the Application | | | | | |
| | | Detection Information, e.g. for envelope reporting. | | | | | |
| | | Immediate Start Time Metering Flag: this | — | X | X | X | |
| | | flag may be set to “1” if time-based measurement | | | | | |
| | | is used and the UP function is requested to start | | | | | |
| | | the time metering immediately at receiving the flag. | | | | | |
| | | Send Start Pause of Charging Flag: this | X | — | — | X | |
| | | flag may be set to “1” by the CP function if the UP | | | | | |
| | | Function is requested to send a Start Pause of | | | | | |
| | | Charging indication to the upstream GTP-U | | | | | |
| | | entity(s) when the Dropped DL Traffic Threshold is | | | | | |
| | | reached. | | | | | |
| | | Applicable for Start of Pause of Charging | — | X | — | X | |
| | | Flag: this flag may be set to “1” if the URR is | | | | | |
| | | applicable for Start of Pause of Charging, so that | | | | | |
| | | the UP function shall stop the usage measurement | | | | | |
| | | for the URR when receiving Start Pause of | | | | | |
| | | Charging indication from the peer downstream | | | | | |
| | | GTP-U entity. | | | | | |
| Time Quota | C | This IE shall be present if time-based measurement based | — | X | — | — | Time Quota |
| Mechanism | | on CTP or DTP needs to be modified. | | | | | Mechanism |
| Aggregated URRs | C | This IE shall be included if the Aggregated URRs IE needs | — | X | — | — | Aggregated |
| | | to be modified. See Table 7.5.2.4-2. | | | | | URRs |
| | | Several IEs with the same IE type may be present to | | | | | |
| | | provision multiple aggregated URRs. | | | | | |
| | | When present, this IE shall provide the complete list of the | | | | | |
| | | aggregated URRs. | | | | | |
| FAR ID for Quota | C | This IE shall be present if the FAR ID for Quota Action IE | — | X | X | X | FAR ID |
| Action | | needs to be modified. This IE may be present if the | | | | | |
| | | Volume Quota IE or the Time Quota IE or Event Quota IE | | | | | |
| | | is newly provisioned in the URR and the UP Function | | | | | |
| | | indicated support of the Quota Action. | | | | | |
| | | When present, it shall contain the identifier of the | | | | | |
| | | substitute FAR the UP function shall apply, for the traffic | | | | | |
| | | associated to this URR, when exhausting any of these | | | | | |
| | | quotas. See NOTE 1. | | | | | |
| Ethernet Inactivity | C | This IE shall be present if the Ethernet Inactivity Timer | — | — | — | X | Ethernet |
| Timer | | needs to be modified. When present, it shall contain the | | | | | Inactivity Timer |
| | | duration of the Ethernet inactivity period. | | | | | |
| Additional | O | This IE shall be present if the additional Monitoring Time | X | X | X | X | Additional |
| Monitoring Time | | needs to be modified. When present, this IE shall contain | | | | | Monitoring Time |
| | | the time at which the UP function shall re-apply the volume | | | | | |
| | | or time or event threshold/quota. See Table 7.5.2.4-3. | | | | | |
| | | The CP function shall provide the full set of Additional | | | | | |
| | | Monitoring Times IE(s). The UP function shall replace any | | | | | |
| | | Additional Monitoring Times IE(s) provisioned earlier by | | | | | |
| | | the new set of received IE(s). | | | | | |
| Number of | O | This IE may be present if the Number of Reports need to | X | X | X | X | Number of |
| Reports | | be changed. When present, it shall indicate the number of | | | | | Reports |
| | | usage reports to be generated by the URR. See also | | | | | |
| | | clauses 5.2.2.2.1 and 5.2.2.3.1. | | | | | |

NOTE 1:
The substitute FAR used when exhausting a Volume Quota or Time Quota may be set to drop the packets or redirect the traffic towards a redirect destination as specified in clause 5.4.7.

### 8.2.25 UP Function Features

The UP Function Features IE indicates the features supported by the UP function. It is coded as depicted in following table.

UP Function Features

| | Bits | | | | | | | |
|---|---|---|---|---|---|---|---|---|
| Octets | 8 | 7 | 6 | 5 | 4 | 3 | 2 | 1 |

| | |
|---|---|
| 1 to 2 | Type = 43 (decimal) |
| 3 to 4 | Length = n |
| 5 to 6 | Supported-Features |
| 7 to 8 | Additional Supported-Features 1 |
| 9 to 10 | Additional Supported-Features 2 |
| 11 to (n + 4) | These octet(s) is/are present only if explicitly specified |

The UP Function Features IE takes the form of a bitmask where each bit set indicates that the corresponding feature is supported. Spare bits shall be ignored by the receiver. The same bitmask is defined for all PFCP interfaces.
The following table specifies the features defined on PFCP interfaces and the interfaces on which they apply.

TABLE 8.2.25-1
UP Function Features

| Feature | | | |
|---|---|---|---|
| Octet/Bit | Feature | Interface | Description |
| 5/1 | BUCP | Sxa, N4 | Downlink Data Buffering in CP function is supported |
| | | | by the UP function. |
| 5/2 | DDND | Sxa, N4 | The buffering parameter ‘Downlink Data Notification |
| | | | Delay’ is supported by the UP function. |
| 5/3 | DLBD | Sxa, N4 | The buffering parameter ‘DL Buffering Duration’ is |
| | | | supported by the UP function. |
| 5/4 | TRST | Sxb, Sxc, N4 | Traffic Steering is supported by the UP function. |
| 5/5 | FTUP | Sxa, Sxb, N4 | F-TEID allocation/release in the UP function is |
| | | | supported by the UP function. |
| 5/6 | PFDM | Sxb, Sxc, N4 | The PFD Management procedure is supported by the |
| | | | UP function. |
| 5/7 | HEEU | Sxb, Sxc, N4 | Header Enrichment of Uplink traffic is supported by |
| | | | the UP function. |
| 5/8 | TREU | Sxb, Sxc, N4 | Traffic Redirection Enforcement in the UP function is |
| | | | supported by the UP function. |
| 6/1 | EMPU | Sxa, Sxb, N4 | Sending of End Marker packets supported by the UP |
| | | | function. |
| 6/2 | PDIU | Sxa, Sxb, Sxc, N4 | Support of PDI optimised signalling in UP function |
| | | | (see clause 5.2.1A.2). |
| 6/3 | UDBC | Sxb, Sxc, N4 | Support of UL/DL Buffering Control |
| 6/4 | QUOAC | Sxb, Sxc, N4 | The UP function supports being provisioned with the |
| | | | Quota Action to apply when reaching quotas. |
| 6/5 | TRACE | Sxa, Sxb, Sxc, N4 | The UP function supports Trace (see clause 5.15). |
| 6/6 | FRRT | Sxb, N4 | The UP function supports Framed Routing (see |
| | | | IETF RFC 2865 [37] and IETF RFC 3162 [38]). |
| 6/7 | PFDE | Sxb, N4 | The UP function supports a PFD Contents including a |
| | | | property with multiple values. |
| 6/8 | EPFAR | Sxa, Sxb, Sxc, N4 | The UP function supports the Enhanced PFCP |
| | | | Association Release feature (see clause 5.18). |
| 7/1 | DPDRA | Sxb, Sxc, N4 | The UP function supports Deferred PDR Activation or |
| | | | Deactivation. |
| 7/2 | ADPDP | Sxa, Sxb, Sxc, N4 | The UP function supports the Activation and |
| | | | Deactivation of Pre-defined PDRs (see clause 5.19). |
| 7/3 | UEIP | Sxb, N4 | The UP function supports allocating UE IP addresses |
| | | | or prefixes (see clause 5.21). |
| 7/4 | SSET | N4 | UPF support of PFCP sessions successively |
| | | | controlled by different SMFs of a same SMF Set (see |
| | | | clause 5.22). |
| 7/5 | MNOP | Sxa, Sxb, Sxc, N4 | The UP function supports measurement of number of |
| | | | packets which is instructed with the flag |
| | | | ‘Measurement of Number of Packets’ in a URR. See |
| | | | also clause 5.2.2.2.1. |
| 7/6 | MTE | N4 | UPF supports multiple instances of Traffic Endpoint |
| | | | IDs in a PDI. |
| 7/7 | BUNDL | Sxa, Sxb, Sxc, N4 | PFCP messages bundling (see clause 6.5) is |
| | | | supported by the UP function. |
| 7/8 | GCOM | N4 | UPF support of 5G VN Group Communication. (See |
| | | | clause 5.23) |
| 8/1 | MPAS | N4 | UPF support for multiple PFCP associations to the |
| | | | SMFs in an SMF set (see clause 5.22.3). |
| 8/2 | RTTL | N4 | UPF supports redundant transmission at transport |
| | | | layer. |
| 8/3 | VTIME | Sxb, N4 | UP function support of quota validity time feature. |
| 8/4 | NORP | Sxa, Sxb, Sxc, N4 | UP function support of Number of Reports as |
| | | | specified in clause 5.2.2.2. |
| 8/5 | IPTV | N4 | UPF support of IPTV service (see clause 5.25) |
| 8/6 | IP6PL | N4 | UPF supports: |
| | | | UE IPv6 address(es) allocation with |
| | | | IPv6 prefix length other than default/64 |
| | | | (including allocating/128 individual IPv6 |
| | | | addresses), as specified in clause 4.6.2.2 of |
| | | | of 3GPP TS 23.316 [57]; and |
| | | | multiple UE IPv6 addresses |
| | | | allocation using multiple instances of the UE |
| | | | IP Address IE in a same PDI or Traffic |
| | | | Endpoint, or using multiple PDIs or Traffic |
| | | | Endpoints with a different UE IP Address as |
| | | | specified in clause 5.21.1. |
| 8/7 | TSCU | N4 | Time Sensitive Communication is supported by the |
| | | | UPF (see clause 5.26). |
| 8/8 | MPTCP | N4 | UPF support of MPTCP Proxy functionality (see |
| | | | clause 5.20) |
| 9/1 | ATSSS-LL | N4 | UPF support of ATSSS-LLL steering functionality |
| | | | (see clause 5.20) |
| 9/2 | QFQM | N4 | UPF support of per QoS flow per UE QoS monitoring |
| | | | (see clause 5.24.4). |
| 9/3 | GPQM | N4 | UPF support of per GTP-U Path QoS monitoring (see |
| | | | clause 5.24.5). |
| 9/4 | MT-EDT | Sxa | SGW-U support of reporting the size of DL Data |
| | | | Packets. (see clause 5.2.4.1). |
| 9/5 | CIOT | Sxb, N4 | UP function support of CIoT feature, e.g. small data |
| | | | packet rate enforcement. (see 5.4.15) |
| 9/6 | ETHAR | N4 | UPF support of Ethernet PDU Session Anchor |
| | | | Relocation (see clause 5.13.6). |
| 9/7 | DDDS | N4 | UPF support of reporting the first buffered/first |
| | | | discarded downlink data after buffering/directly |
| | | | dropped downlink data for downlink data delivery |
| | | | status notification. |
| 9/8 | RDS | Sxb, N4 | UP function support of Reliable Data Service (see |
| | | | clause 5.29). |
| 10/1 | RTTWP | N4 | UPF support of RTT measurements towards the UE |
| | | | Without PMF. |
| 10/2 | NSPOC | Sxb, N4 | UP function supports notifying start of Pause of |
| | | | Charging via user plane. |

Feature Octet/Bit: The octet and bit number within the Supported-Features IE, e.g. “5/1”.
Feature: A short name that can be used to refer to the octet/bit and to the feature.
Interface: A list of applicable interfaces to the feature.
Description: A clear textual description of the feature.

### 8.2.68 Measurement Information

The Measurement Information IE shall be encoded as shown in following table. It provides information on the requested measurement information.

Measurement Information

| | Bits | | | | | | | |
|---|---|---|---|---|---|---|---|---|
| Octets | 8 | 7 | 6 | 5 | 4 | 3 | 2 | 1 |

| 1 to 2 | Type = 100 (decimal) | | | | | |
|---|---|---|---|---|---|---|
| 3 to 4 | Length = n | | | | | |
| 5 | Spare | MNOP | ISTM | RADI | INAM | MBQE |

| | |
|---|---|
| 6 to (n + 4) | These octet(s) is/are present only if explicitly specified |

Octet 5 shall be encoded as follows:
Bit 1—MBQE (Measurement Before QoS Enforcement): when set to “1”, this indicates a request to measure the traffic usage before QoS enforcement.
Bit 2—INAM (Inactive Measurement): when set to “1”, this indicates that the measurement shall be paused (inactive).

1 Bit 3—RADI (Reduced Application Detection Information): when set to “1”, this indicates that the Application Detection Information reported to the CP function, upon detecting the start or stop of an application, shall only contain the Application ID.
Bit 4—ISTM (Immediate Start Time Metering): when set to “1”, this indicates that time metering shall start immediately when the flag is received.
Bit 5—MNOP (Measurement of Number of Packets): when set to “1”, this indicate a request to measure the number of packets transferred in UL/DL/Total in addition to the measurement in octets when Volume based measurement applies.
Bit 6—SSPOC (Send Start Pause of Charging): when set to “1”, this indicate that the UP Function shall send a Start Pause of Charging indication to the upstream GTP-U entity(s) when the Dropped DL Traffic Threshold is reached.
Bits 7—ASPOC (Applicable for Start of Pause of Charging): when set to “1”, this indicate that UP Function the the URR is applicable for Start of Pause of Charging, so that it shall stop the usage measurement for the URR when receiving Start Pause of Charging indication from the peer downstream GTP-U entity.
Bits 6 to 8: Spare, for future use and set to “0”.
   At least one bit shall be set to “1”. Several bits may be set to “1”, e.g. both MBQE and MNOP bits are set to “1”.

In an embodiment, the following content may be added in 3GPP TS29.281 V16.1.0.

### 7.7.0 General

A GTP Signalling message may contain several information elements. The TLV (Type, Length, Value) or TV (Type, Value) encoding format shall be used for the GTP information elements. The information elements shall be sorted, with the Type fields in ascending order, in the signalling messages. The Length field contains the length of the information element excluding the Type and Length field.
For all the length fields, bit 8 of the lowest numbered octet is the most significant bit and bit 1 of the highest numbered octet is the least significant bit.
Within information elements, certain fields may be described as spare. These bits shall be transmitted with the value defined for them. To allow for future features, the receiver shall not evaluate these bits.
The most significant bit in the Type field is set to 0 when the TV format is used and set to 1 for the TLV format.

Type field for TV and TLV format

Bits

| Octets | 8 | 7 | 6 | 5 | 4 | 3 | 2 | 1 |
|---|---|---|---|---|---|---|---|---|
| | z | z | z | z | z | z | z | z |

| | | |
|---|---|---|
| 1 | 0 | Type −> TV format |
| | 1 | Type −> TLV format |

In Table 37 the Length Type may be Fixed, Variable, or Extendable. These are defined as follows:
Infoiivation elements with Length Type of Fixed have a fixed set of fields and a fixed number of octets. They have the number of the last octet with a fixed value, e.g., “4”.
Infoimation elements with Length Type of Variable have a fixed set of fields and a variable number of octets. They have the number of the last octet with a variable value, e.g., “n”. Variable length info lation elements shall never have any new octet fields added beyond the last variable octet.
Infoimation elements with Length Type of Extendable have a variable number of fields and a variable number of octets. They have the number of the last octet with a variable value, e.g., “n” and also have the following description: “These octet(s) is/are present only if explicitly specified”.
   TV format information elements shall always have Length Type of Fixed. TLV format information elements may have Length Type Fixed, Variable or Extendable.

TABLE 37
Information Elements

| IE Type | | | | Length | Number of |
|---|---|---|---|---|---|
| Value | Format | Information Element | Reference | Type | Fixed Octets |
| 0 | TV | Reserved. | | | |
| 1 | TV | Cause | 7.7.1 | Fixed | 1 |
| 2 | TV | International Mobile Subscriber | 7.7.2 | Fixed | 8 |
| | | Identity (IMSI) | | | |
| 3 | TV | Routeing Area Identity (RAI) | 7.7.3 | Fixed | 6 |
| 4 | TV | Temporary Logical Link Identity (TLLI) | 7.7.4 | Fixed | 4 |
| 5 | TV | Packet TMSI (P-TMSI) | 7.7.5 | Fixed | 4 |
| 6-7 | Spare | | | | |
| 8 | TV | Reordering Required | 7.7.6 | Fixed | 1 |
| 9 | TV | Authentication Triplet | 7.7.7 | Fixed | 28 |
| 10 | Spare | | | | |
| 11 | TV | MAP Cause | 7.7.8 | Fixed | 1 |
| 12 | TV | P-TMSI Signature | 7.7.9 | Fixed | 3 |
| 13 | TV | MS Validated | 7.7.10 | Fixed | 1 |
| 14 | TV | Recovery | 7.7.11 | Fixed | 1 |
| 15 | TV | Selection Mode | 7.7.12 | Fixed | 1 |
| 16 | TV | Tunnel Endpoint Identifier Data I | 7.7.13 | Fixed | 4 |
| 17 | TV | Tunnel Endpoint Identifier Control | 7.7.14 | Fixed | 4 |
| | | Plane | | | |
| 18 | TV | Tunnel Endpoint Identifier Data II | 7.7.15 | Fixed | 5 |
| 19 | TV | Teardown Ind | 7.7.16 | Fixed | 1 |
| 20 | TV | NSAPI | 7.7.17 | Fixed | 1 |
| 21 | TV | RANAP Cause | 7.7.18 | Fixed | 1 |
| 22 | TV | RAB Context | 7.7.19 | Fixed | 9 |
| 23 | TV | Radio Priority SMS | 7.7.20 | Fixed | 1 |
| 24 | TV | Radio Priority | 7.7.21 | Fixed | 1 |
| 25 | TV | Packet Flow Id | 7.7.22 | Fixed | 2 |
| 26 | TV | Charging Characteristics | 7.7.23 | Fixed | 2 |
| 27 | TV | Trace Reference | 7.7.24 | Fixed | 2 |
| 28 | TV | Trace Type | 7.7.25 | Fixed | 2 |
| 29 | TV | MS Not Reachable Reason | 7.7.25A | Fixed | 1 |
| 30-116 | TV | Reserved. (No TV types can now be | | | |
| | | allocated) | | | |
| 117-126 | Reserved for the GPRS charging protocol (see GTP′ in 3GPP TS 32.295 [33]) | | | | |
| 127 | TV | Charging ID | 7.7.26 | Fixed | 4 |
| 128 | TLV | End User Address | 7.7.27 | Variable | Not |
| | | | | | Applicable |
| 129 | TLV | MM Context | 7.7.28 | Variable | Not |
| | | | | | Applicable |
| 130 | TLV | PDP Context | 7.7.29 | Variable | Not |
| | | | | | Applicable |
| 131 | TLV | Access Point Name | 7.7.30 | Variable | Not |
| | | | | | Applicable |
| 132 | TLV | Protocol Configuration Options | 7.7.31 | Variable | Not |
| | | | | | Applicable |
| 133 | TLV | GSN Address | 7.7.32 | Variable | Not |
| | | | | | Applicable |
| 134 | TLV | MS International PSTN/ISDN Number | 7.7.33 | Variable | Not |
| | | (MSISDN) | | | Applicable |
| 135 | TLV | Quality of Service Profile | 7.7.34 | Variable | Not |
| | | | | | Applicable |
| 136 | TLV | Authentication Quintuplet | 7.7.35 | Variable | Not |
| | | | | | Applicable |
| 137 | TLV | Traffic Flow Template | 7.7.36 | Variable | Not |
| | | | | | Applicable |
| 138 | TLV | Target Identification | 7.7.37 | Variable | Not |
| | | | | | Applicable |
| 139 | TLV | UTRAN Transparent Container | 7.7.38 | Variable | Not |
| | | | | | Applicable |
| 140 | TLV | RAB Setup Information | 7.7.39 | Variable | Not |
| | | | | | Applicable |
| 141 | TLV | Extension Header Type List | 7.7.40 | Variable | Not |
| | | | | | Applicable |
| 142 | TLV | Trigger Id | 7.7.41 | Variable | Not |
| | | | | | Applicable |
| 143 | TLV | OMC Identity | 7.7.42 | Variable | |
| 144 | TLV | RAN Transparent Container | 7.7.43 | Variable | Not |
| | | | | | Applicable |
| 145 | TLV | PDP Context Prioritization | 7.7.45 | Fixed | 0 |
| 146 | TLV | Additional RAB Setup Information | 7.7.45A | Variable | Not |
| | | | | | Applicable |
| 147 | TLV | SGSN Number | 7.7.47 | Variable | Not |
| | | | | | Applicable |
| 148 | TLV | Common Flags | 7.7.48 | Fixed | 1 |
| 149 | TLV | APN Restriction | 7.7.49 | Fixed | 1 |
| 150 | TLV | Radio Priority LCS | 7.7.25B | Fixed | 1 |
| 151 | TLV | RAT Type | 7.7.50 | Fixed | 1 |
| 152 | TLV | User Location Information | 7.7.51 | Variable | Not |
| | | | | | Applicable |
| 153 | TLV | MS Time Zone | 7.7.52 | Fixed | 1 |
| 154 | TLV | IMEI(SV) | 7.7.53 | Fixed | 8 |
| 155 | TLV | CAMEL Charging Information | 7.7.54 | Variable | Not |
| | | Container | | | Applicable |
| 156 | TLV | MBMS UE Context | 7.7.55 | Variable | Not |
| | | | | | Applicable |
| 157 | TLV | Temporary Mobile Group Identity | 7.7.56 | Fixed | 6 |
| | | (TMGI) | | | |
| 158 | TLV | RIM Routing Address | 7.7.57 | Variable | Not |
| | | | | | Applicable |
| 159 | TLV | MBMS Protocol Configuration Options | 7.7.58 | Variable | Not |
| | | | | | Applicable |
| 160 | TLV | MBMS Service Area | 7.7.60 | Variable | Not |
| | | | | | Applicable |
| 161 | TLV | Source RNC PDCP context info | 7.7.61 | Variable | Not |
| | | | | | Applicable |
| 162 | TLV | Additional Trace Info | 7.7.62 | Fixed | 9 |
| 163 | TLV | Hop Counter | 7.7.63 | Fixed | 1 |
| 164 | TLV | Selected PLMN ID | 7.7.64 | Fixed | 3 |
| 165 | TLV | MBMS Session Identifier | 7.7.65 | Fixed | 1 |
| 166 | TLV | MBMS 2G/3G Indicator | 7.7.66 | Fixed | 1 |
| 167 | TLV | Enhanced NSAPI | 7.7.67 | Fixed | 1 |
| 168 | TLV | MBMS Session Duration | 7.7.59 | Fixed | 3 |
| 169 | TLV | Additional MBMS Trace Info | 7.7.68 | Fixed | 8 |
| 170 | TLV | MBMS Session Repetition Number | 7.7.69 | Fixed | 1 |
| 171 | TLV | MBMS Time To Data Transfer | 7.7.70 | Fixed | 1 |
| 172 | Reserved (NOTE 1) | | | | |
| 173 | TLV | BSS Container | 7.7.72 | Variable | Not |
| | | | | | Applicable |
| 174 | TLV | Cell Identification | 7.7.73 | Fixed | 17 |
| 175 | TLV | PDU Numbers | 7.7.74 | Fixed | 9 |
| 176 | TLV | BSSGP Cause | 7.7.75 | Fixed | 1 |
| 177 | TLV | Required MBMS bearer capabilities | 7.7.76 | Variable | Not |
| | | | | | Applicable |
| 178 | TLV | RIM Routing Address Discriminator | 7.7.77 | Fixed | 1 |
| 179 | TLV | List of set-up PFCs | 7.7.78 | Variable | Not |
| | | | | | Applicable |
| 180 | TLV | PS Handover XID Parameters | 7.7.79 | Variable | Not |
| | | | | | Applicable |
| 181 | TLV | MS Info Change Reporting Action | 7.7.80 | Fixed | 1 |
| 182 | TLV | Direct Tunnel Flags | 7.7.81 | Variable | Not |
| | | | | | Applicable |
| 183 | TLV | Correlation-ID | 7.7.82 | Fixed | 1 |
| 184 | TLV | Bearer Control Mode | 7.7.83 | Fixed | 1 |
| 185 | TLV | MBMS Flow Identifier | 7.7.84 | Variable | Not |
| | | | | | Applicable |
| 186 | TLV | MBMS IP Multicast Distribution | 7.7.85 | Variable | Not |
| | | | | | Applicable |
| 187 | TLV | MBMS Distribution Acknowledgement | 7.7.86 | Fixed | 1 |
| 188 | TLV | Reliable INTER RAT HANDOVER | 7.7.87 | Fixed | 1 |
| | | INFO | | | |
| 189 | TLV | RFSP Index | 7.7.88 | Fixed | 2 |
| 190 | TLV | Fully Qualified Domain Name (FQDN) | 7.7.90 | Variable | Not |
| | | | | | Applicable |
| 191 | TLV | Evolved Allocation/Retention Priority I | 7.7.91 | Fixed | 1 |
| 192 | TLV | Evolved Allocation/Retention Priority II | 7.7.92 | Fixed | 2 |
| 193 | TLV | Extended Common Flags | 7.7.93 | Variable | Not |
| | | | | | Applicable |
| 194 | TLV | User CSG Information (UCI) | 7.7.94 | Fixed | 8 |
| 195 | TLV | CSG Information Reporting Action | 7.7.95 | Variable | Not |
| | | | | | Applicable |
| 196 | TLV | CSG ID | 7.7.96 | Fixed | 4 |
| 197 | TLV | CSG Membership Indication (CMI) | 7.7.97 | Fixed | 1 |
| 198 | TLV | Aggregate Maximum Bit Rate (AMBR) | 7.7.98 | Fixed | 8 |
| 199 | TLV | UE Network Capability | 7.7.99 | Variable | Not |
| | | | | | Applicable |
| 200 | TLV | UE-AMBR | 7.7.100 | Variable | Not |
| | | | | | Applicable |
| 201 | TLV | APN-AMBR with NSAPI | 7.7.101 | Fixed | 9 |
| 202 | TLV | GGSN Back-Off Time | 7.7.102 | Extendable | 1 |
| 203 | TLV | Signalling Priority Indication | 7.7.103 | Extendable | 1 |
| 204 | TLV | Signalling Priority Indication with | 7.7.104 | Extendable | 2 |
| | | NSAPI | | | |
| 205 | TLV | Higher bitrates than 16 Mbps flag | 7.7.105 | Fixed | 1 |
| 206 | Reserved (NOTE 1) | | | | |
| 207 | TLV | Additional MM context for SRVCC | 7.7.107 | Extendable | “e - 3” (See |
| | | | | | Figure |
| | | | | | 7.7.107-1) |
| 208 | TLV | Additional flags for SRVCC | 7.7.108 | Extendable | 1 |
| 209 | TLV | STN-SR | 7.7.109 | Variable | Not |
| | | | | | Applicable |
| 210 | TLV | C-MSISDN | 7.7.110 | Variable | Not |
| | | | | | Applicable |
| 211 | TLV | Extended RANAP Cause | 7.7.111 | Extendable | 2 |
| 212 | TLV | eNodeB ID | 7.7.112 | Variable | Not |
| | | | | | Applicable |
| 213 | TLV | Selection Mode with NSAPI | 7.7.113 | Fixed | 2 |
| 214 | TLV | ULI Timestamp | 7.7.114 | Extendable | 4 |
| 215 | TLV | Local Home Network ID (LHN-ID) with | 7.7.115 | Variable | Not |
| | | NSAPI | | | Applicable |
| 216 | TLV | CN Operator Selection Entity | 7.7.116 | Extendable | 1 |
| 217 | TLV | UE Usage Type | 7.7.117 | Variable | Not |
| | | | | | Applicable |
| 218 | TLV | Extended Common Flags II | 7.7.118 | Extendable | 1 |
| 219 | TLV | Node Identifier | 7.7.119 | Variable | Not |
| | | | | | Applicable |
| 220 | TLV | CIoT Optimizations Support Indication | 7.7.120 | Extendable | 1 |
| 221 | TLV | SCEF PDN Connection | 7.7.121 | Extendable | Not |
| | | | | | Applicable |
| 222 | TLV | IOV_updates counter | 7.7.122 | Fixed | 1 |
| 223 | TLV | Mapped UE Usage Type | 7.7.123 | Extendable | 2 |
| 224 | TLV | UP Function Selection Indication | 7.7.124 | Extendable | 1 |
| | | Flags | | | |
| 225-229 | TLV | Spare. For future use. | | | |
| 230-237 | Reserved for the GTPv1-U protocol as specified in 3GPP TS 29.281 [41]) | | | | |
| 238 | TLV | Special IE type for IE Type Extension | See | Not Applicable | Not |
| | | | NOTE3 | | Applicable |
| 239-250 | Reserved for the GPRS charging protocol (see GTP′ in 3GPP TS 32.295 [33]) | | | | |
| 251 | TLV | Charging Gateway Address | 7.7.44 | | 4/16 |
| 252-254 | Reserved for the GPRS charging protocol (see GTP′ in 3GPP TS 32.295 [33]) | | | | |
| 255 | TLV | Private Extension | 7.7.46 | | Not |
| | | | | | Applicable |
| 256-65535 | TLV | Spare. For future use. | | | |

NOTE 1:
This value was allocated in an earlier version of the specification.
NOTE 2:
The size of the TL (Type and Length) fields, i.e “3” octets, is subtracted from the number of the fixed octets of the Fixed Length and Extendable type of the IEs. Hence for some of the Extendable IEs, for which the length is defined in terms of variable number of octets, “3” is explicitly subtracted while defining the fixed number of octets. E.g. length of Additional MM Context for SRVCC is defined as “e” and fixed number of octets for the same is defined as “e-3”.
NOTE3:
The IE Type value 238 indicates that the IE Type shall be further identified by an IE Type Extension field; see clause 7.7.0A. A GTP-C entity which does not support any IE Type encoded with an IE Type Extension field shall ignore an IE received with the IE Type value 238.

In an embodiment, the following content may be added in 3GPP TS29.502 V V16.6.0.

TABLE 6.1.8-1
Features of supported Features attribute used by Nsmf_PDUSession service

| Feature | | | |
|---|---|---|---|
| Number | Feature | M/O | Description |
| 1 | CIOT | O | Cellular IoT |
| | | | Support of this feature implies the support of all the CIoT features specified in |
| | | | clause 5.31 of 3GPP TS 23.501 [2], including in particular corresponding SMF |
| | | | PDUSession service's extensions to support: |
| | | | NB-IOT and LTE-M RAT types; |
| | | | Control Plane CIoT 5GS Optimisation; |
| | | | Rate control of user data; |
| | | | Idle mode mobility with data forwarding between EPS and 5GS using |
| | | | N26 interface. |
| | | | The SMF shall indicate its support of this feature in supportedFeatures attribute |
| | | | in its profile registered in NRF. |
| | | | A NF service consumer (e.g. AMF) shall only select SMF(s) that supports this |
| | | | feature for PDU sessions with Control Plane CIoT 5GS Optimisation enabled. |
| 2 | MAPDU | O | Multi-Access PDU Session |
| | | | An SMF that supports this feature shall support the procedures specified |
| | | | in3GPP TS 23.501 [2] and 3GPP TS 23.502 [3] related to Access Traffic |
| | | | Steering, Switching and Splitting. |
| 3 | DTSSA | O | Deployments Topologies with specific SMF Service Areas |
| | | | A NF Service Consumer and an SMF that support this feature shall support the |
| | | | procedures specified in clause 5.34 of 3GPP TS 23.501 [2] and in clause 4.23 |
| | | | of 3GPP TS 23.502 [3]. |
| 4 | CARPT | O | SMF derived CN Assisted RAN parameters Tuning. |
| | | | A NF Service Consumer (e.g. AMF) and an SMF that support this feature shall |
| | | | support exchanging SMF derived CN assisted RAN parameters in Notify SM |
| | | | Context Status service operation (see clause 5.2.2.5.1). |
| 5 | CTXTR | O | This feature bit indicates whether the NF Service Consumer (e.g. AMF) and |
| | | | SMF supports Network Function/NF Service Context Transfer Procedures |
| | | | specified in clause 4.26 of 3GPP TS 23.502 [3]. |
| | | | The SMF shall only trigger these context transfer procedures if the NF Service |
| | | | Consumer has indicated support of this feature. |
| 6 | VQOS | O | VPLMN QoS |
| | | | An SMF that supports this feature shall support QoS modification initiated by |
| | | | VPLMN, as specified in clause 4.3.3.3 of 3GPP TS 23.502 [3]. |
| 7 | HOFAIL | M | This feature bit indicates whether the NF Service Consumer (e.g. AMF, V-SMF, |
| | | | I-SMF) and SMF supports the Notify (SM Context) Status procedure to indicate |
| | | | a handover failure with the ResourceStatus set to “UPDATED” between 3GPP |
| | | | access and non-3GPP access as specified in clauses 5.2.2.5.1 and 5.2.2.10.1. |
| | | | The SMF shall only trigger such a resource status notify procedure if the NF |
| | | | Service Consumer has indicated support of this feature. |
| 8 | ISPOC | O | UP function supports immediately start of pause of charging. |

Feature number: The order number of the feature within the supportedFeatures attribute (starting with 1).
Feature: A short name that can be used to refer to the bit and to the feature.
M/O: Defines if the implementation of the feature is mandatory (“M”) or optional (“O”).
Description: A clear textual description of the feature.

Embodiments herein afford many advantages, of which a non-exhaustive list of examples follows. Some embodiments herein may solve the over-charging problem of pause of charging in at least one of scenarios: 4G CUPS with SGW-C and PGW-C, 5G Roaming with V-SMF and H-SMF, 5G with I-SMF and I-UPF inserted, and 5G with I-UPF inserted and without I-SMF inserted. Some embodiments herein may increase the network quality. Some embodiments herein may improve the operator's satisfaction. Some embodiments herein may improve the user's satisfaction. The embodiments herein are not limited to the features and advantages mentioned above. A person skilled in the art will recognize additional features and advantages upon reading the following detailed description.

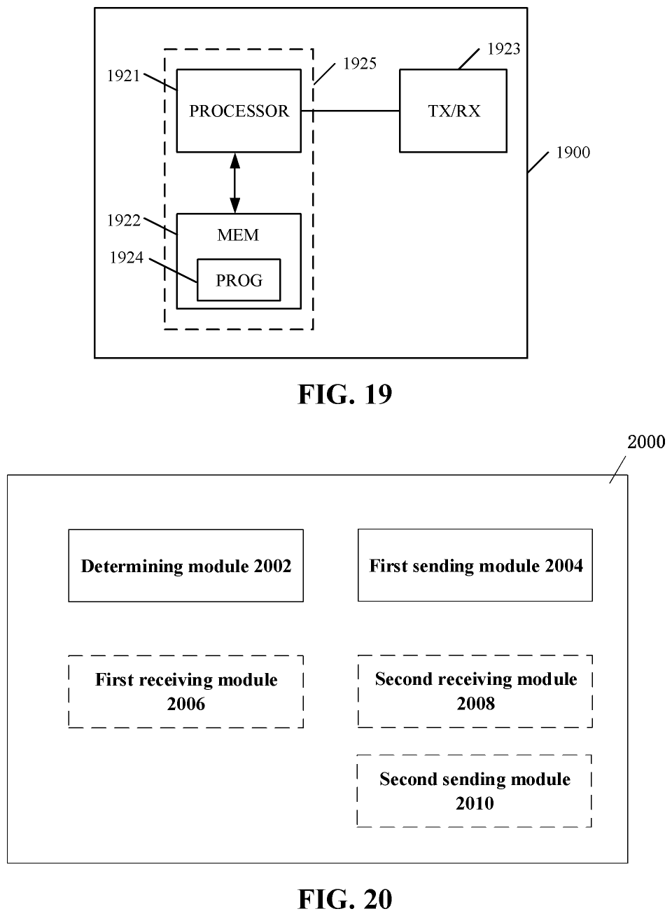

FIG. 19 is a block diagram showing an apparatus suitable for use in practicing some embodiments of the disclosure. For example, any one of the first control plane function, the first user plane function and the second user plane function described above may be implemented through the apparatus 1900.

The apparatus 1900 comprises at least one processor 1921, such as a DP, and at least one MEM 1922 coupled to the processor 1921. The apparatus 1920 may further comprise a transmitter TX and receiver RX 1923 coupled to the processor 1921. The MEM 1922 stores a PROG 1924. The PROG 1924 may include instructions that, when executed on the associated processor 1921, enable the apparatus 1920 to operate in accordance with the embodiments of the present disclosure. A combination of the at least one processor 1921 and the at least one MEM 1922 may form processing means 1925 adapted to implement various embodiments of the present disclosure.

Various embodiments of the present disclosure may be implemented by computer program executable by one or more of the processor 1921, software, firmware, hardware or in a combination thereof

The MEM 1922 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 1921 may be of any type suitable to the local technical environment, and may include one or more of general purpose computers, special purpose computers, microprocessors, digital signal processors DSPs and processors based on multicore processor architecture, as non-limiting examples.

In an embodiment where the apparatus is implemented as or at the first control plane function, the memory 1922 contains instructions executable by the processor 1921, whereby the first control plane function operates according to any one of the methods related to the first control plane function as described above.

In an embodiment where the apparatus is implemented as or at the first user plane function, the memory 1922 contains instructions executable by the processor 1921, whereby the first user plane function operates according to any one of the methods related to the first user plane function as described above.

In an embodiment where the apparatus is implemented as or at the second user plane function, the memory 1922 contains instructions executable by the processor 1921, whereby the second user plane function operates according to any one of the methods related to the second user plane function as described above.

FIG. 20 illustrates a simplified block diagram of a first user plane function according to an embodiment of the present disclosure. The first user plane function 2000 comprises a determining module 2002 and a first sending module 2004. The determining module 2002 is configured to determine a charging action for a first session. The first sending module 2004 is configured to send information regarding the charging action for the first session to a second user plane function.

In an embodiment the first user plane function 2000 further comprises a first receiving module 2006 configured to receive an acknowledgement for the information regarding the charging action for the first session from the second user plane function.

In an embodiment the first user plane function 2000 further comprises a second receiving module 2008 configured to receive, from a control plane function, an indication for sending information regarding a charging action for a second session to another user plane function after determining the charging action for the second session.

In an embodiment the first user plane function 2000 further comprises a second sending module 2010 configured to send a supported feature of the first user plane function to a control plane function. The supported feature of the first user plane function indicates that the first user plane function supports sending and/or receiving information regarding a charging action for a session to and/or from another user plane function.

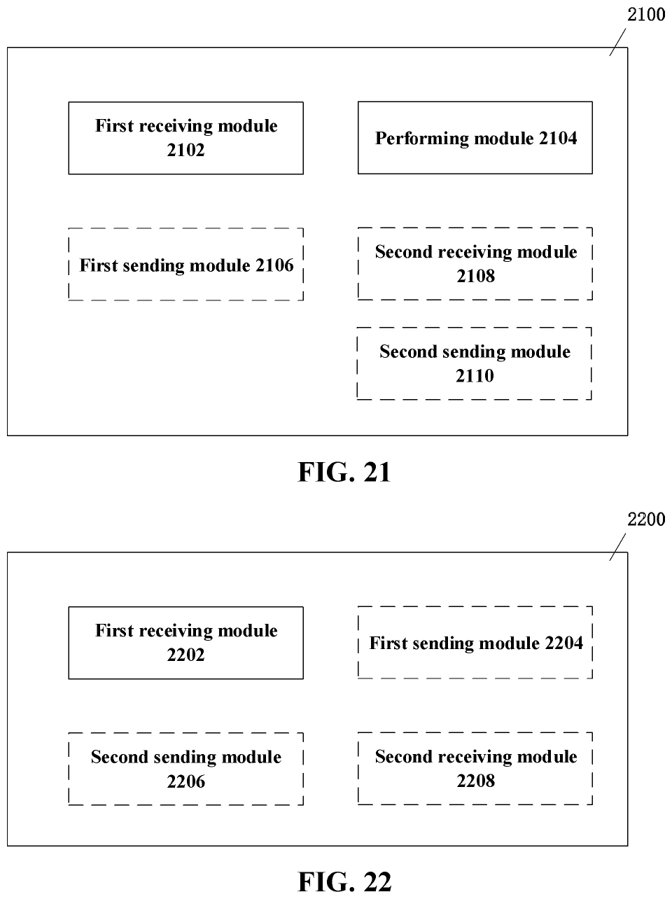

FIG. 21 illustrates a simplified block diagram of a second user plane function according to an embodiment of the present disclosure. The second user plane function 2100 comprises a first receiving module 2102 and a performing module 2104. The first receiving module 2102 is configured to receive information regarding a charging action for a first session from a first user plane function. The performing module 2104 is configured to perform the charging action for the first session based on the information regarding the charging action for the first session.

In an embodiment the second user plane function 2100 further comprises a first sending module 2106 configured to send an acknowledgement for the information regarding the charging action for the first session to the first user plane function.

In an embodiment the second user plane function 2100 further comprises a second receiving module 2108 configured to receive, from a control plane function, an indication of whether a usage reporting rule is applicable for a charging action received from another user plane function.

In an embodiment the second user plane function 2100 further comprises a second sending module 2110 configured to send a supported feature of the second user plane function to a control plane function. The supported feature of the second user plane function indicates that the second user plane function supports sending and/or receiving information regarding a charging action for a session to and/or from another user plane function.

FIG. 22 illustrates a simplified block diagram of a first control plane function according to an embodiment of the present disclosure. The first control plane function 2200 comprises a first receiving module 2202. The first receiving module 2202 is configured to receive a supported feature of a user plane function from a user plane function. The supported feature of the user plane function indicates that the user plane function supports sending and/or receiving information regarding a charging action for a session to and/or from another user plane function.

In an embodiment the first control plane function 2200 further comprises a first sending module 2204 configured to send, to the user plane function, an indication for sending information regarding a charging action for a session to another user plane function after determining the charging action for the session.

In an embodiment the first control plane function 2200 further comprises a second sending module 2206 configured to send a supported feature of the first control plane function to a second control plane function. The supported feature of the first control plane function indicates that the first control plane function supports to configure a user plane function to send and/or receive information regarding a charging action for a session to and/or from another user plane function.

In an embodiment the first control plane function 2200 further comprises a second receiving module 2208 configured to receive a supported feature of a second control plane function from the second control plane function. The supported feature of the second control plane function indicates that the second control plane function supports to configure a user plane function to send and/or receive information regarding a charging action for a session to and/or from another user plane function.

According to an aspect of the disclosure it is provided a computer program product being tangibly stored on a computer readable storage medium and including instructions which, when executed on at least one processor, cause the at least one processor to perform any of the methods related to the first control plane function, the first user plane function and the second user plane function as described above.

According to an aspect of the disclosure it is provided a computer-readable storage medium storing instructions which when executed by at least one processor, cause the at least one processor to perform any of the methods related to the first control plane function, the first user plane function and the second user plane function as described above.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1. A method performed by a first user plane function, comprising:
determining a charging action for a first session; and
sending information regarding the charging action for the first session to a second user plane function.

2. The method according to claim 1, further comprising:
receiving an acknowledgement for the information regarding the charging action for the first session from the second user plane function, and
wherein the information regarding the charging action for the first session is comprised in a GTP-U (general packet radio service tunnelling protocol for user plane) tunnel status message and the acknowledgement for the information regarding the charging action for the first session is comprised in another GTP-U tunnel status message.

3. (canceled)

4. The method according to claim 1, wherein the charging action comprises immediate start of pause of charging, and wherein sending the information comprises immediately sending the information after determining the charging action for the first session, and wherein the charging action is determined based on at least one of:
an operator policy, or
an operator configuration.

5.-6. (canceled)

7. The method according to claim 1, further comprising:
receiving, from a control plane function, an indication for sending information regarding a charging action for a second session to another user plane function after determining the charging action for the second session.

8. The method according to claim 7, wherein the indication is comprised in at least one of:
a PFCP (packet forwarding control protocol) session establishment request, or
a PFCP session modification request,.
wherein the control plane function comprises at least one of a PGW-C (packet data network control plane), an SGW-C (serving gateway control plane), or an SMF (session management function);
wherein the first user plane function comprises at least one of an SGW-U (serving gateway user plane), a V-UPF (visited user plane function), or an I-UPF (intermediate user plane function); and
wherein the second user plane function comprises at least one of a PGW-U (packet data network user plane), an I-UPF (intermediate user plane function), an H-UPF (home user plane function).

9. The method according to claim 1, further comprising:
sending a supported feature of the first user plane function to a control plane function, wherein the supported feature of the first user plane function indicates that the first user plane function supports sending and/or receiving information regarding a charging action for a session to and/or from another user plane function.

10. The method according to claim 9, wherein the supported feature of the first user plane function is comprised in a PFCP (packet forwarding control protocol) association setup response or request .
wherein the control plane function comprises at least one of a PGW-C (packet data network control plane), an SGW-C (serving gateway control plane), or an SMF (session management function);
wherein the first user plane function comprises at least one of an SGW-U (serving gateway user plane), a V-UPF (visited user plane function), or an I-UPF (intermediate user plane function); and
wherein the second user plane function comprises at least one of a PGW-U (packet data network user plane), an I-UPF (intermediate user plane function), an H-UPF (home user plane function).

11 -13. (canceled)

14. A method performed by a second user plane function, comprising:
receiving information regarding a charging action for a first session from a first user plane function; and
performing the charging action for the first session based on the information regarding the charging action for the first session.

15. The method according to claim 14, further comprising:
sending an acknowledgement for the information regarding the charging action for the first session to the first user plane function, and
wherein the information regarding the charging action for the first session is comprised in a GTP-U (general packet radio service tunnelling protocol for user plane) tunnel status message and the acknowledgement for the information regarding the charging action for the first session is comprised in another GTP-U tunnel status message.

16. (canceled)

17. The method according to claim 14, wherein the charging action comprises immediate start of pause of charging;
wherein performing the charging action comprises immediately performing the charging action after receiving the information; and
wherein the charging action is determined based on at least one of:
an operator policy, or
an operator configuration.

18.-19. (canceled)

20. The method according to claim 14, further comprising:
receiving, from a control plane function, an indication of whether a usage reporting rule is applicable for a charging action received from another user plane function.

21. The method according to claim 20, wherein the indication is comprised in at least one of:
a PFCP (packet forwarding control protocol) session establishment request, or
a PFCP session modification request; and
wherein the control plane function comprises at least one of a PGW-C (packet data network control plane), an SGW-C (serving gateway control plane), or an SMF (session management function).

22. The method according to claim 14, further comprising:
sending a supported feature of the second user plane function to a control plane function, wherein the supported feature of the second user plane function indicates that the second user plane function supports sending and/or receiving information regarding a charging action for a session to and/or from another user plane function.

23. The method according to claim 22, wherein the supported feature of the second user plane function is comprised in a PFCP (packet forwarding control protocol) association setup response or request; and
wherein the control plane function comprises at least one of a PGW-C (packet data network control plane), an SGW-C (serving gateway control plane), or an SMF (session management function).

24. (canceled)

25. The method according to claim 14, wherein the first user plane function comprises at least one of:
a serving gateway user plane, SGW-U,
a visited user plane function, V-UPF; or
an intermediate user plane function, I-UPF; and
wherein the second user plane function comprises at least one of:
a packet data network user plane, PGW-U,
an intermediate user plane function, I-UPF,
a home user plane function, H-UPF, or
an anchor user plane function, A-UPF.

26. (canceled)

27. A method performed by a first control plane function, comprising:
receiving a supported feature of a user plane function from a user plane function, wherein the supported feature of the user plane function indicates that the user plane function supports sending and/or receiving information regarding a charging action for a session to and/or from another user plane function.

28. The method according to claim 27, wherein the supported feature of the user plane function is comprised in a packet forwarding control protocol, PFCP, association setup response or request.

29. The method according to claim 27, further comprising:
sending, to the user plane function, an indication for sending information regarding a charging action for a session to another user plane function after determining the charging action for the session; and
wherein the indication is comprised in at least one of a PFCP (packet forwarding control protocol) session establishment request, or a PFCP session modification request.

30. (canceled)

31. The method according to claim 27, wherein the charging action comprises immediate start of pause of charging; and
wherein the charging action is determined based on at least one of:
an operator policy, or
an operator configuration.

32. (canceled)

33. The method according to claim 27, further comprising:
sending a supported feature of the first control plane function to a second control plane function, wherein the supported feature of the first control plane function indicates that the first control plane function supports to configure a user plane function to send and/or receive information regarding a charging action for a session to and/or from another user plane function;
receiving a supported feature of a second control plane function from the second control plane function, wherein the supported feature of the second control plane function indicates that the second control plane function supports to configure a user plane function to send and/or receive information regarding a charging action for a session to and/or from another user plane function, and
wherein the supported feature of the first control plane function is comprised in a session create request, and the supported feature of the second control plane function is comprised in a session create response.

34.-36. (canceled)

37. A first user plane function, comprising:
a processor; and
a memory coupled to the processor, the memory containing instructions executable by said processor, whereby the first user plane function is operative to:
determine a charging action for a first session; and
send information regarding the charging action for the first session to a second user plane function.

38. The first user plane function according to claim 37, wherein the first user plane function is further operative to send a supported feature of the first user plane function to a control plane function, wherein the supported feature of the first user plane function indicates that the first user plane function supports sending and/or receiving information regarding a charging action for a session to and/or from another user plane function.

39. A second user plane function, comprising:
a processor; and
a memory coupled to the processor, the memory containing instructions executable by said processor, whereby the second user plane function is operative to:
receive information regarding a charging action for a first session from a first user plane function; and
perform the charging action for the first session based on the information regarding the charging action for a session.

40. The second user plane function according to claim 39, wherein the second user plane function is further operative to receive, from a control plane function, an indication of whether a usage reporting rule is applicable for a charging action received from another user plane function.

41. A first control plane function, comprising:
a processor; and
a memory coupled to the processor, the memory containing instructions executable by said processor, whereby s-aid the first control plane function is operative to:
receive a supported feature of a user plane function from a user plane function, wherein the supported feature of the user plane function indicates that the user plane function supports sending and/or receiving information regarding a charging action for a session to and/or from another user plane function.

42. The first control plane function according to claim 41, wherein the first control plane function is further operative to send, to the user plane function, an indication for sending information regarding a charging action for a session to another user plane function after determining the charging action for the session.

43.-44. (canceled)
